(19) United States
(12) Patent Application Publication
(10) Pub. No.: US 2007/0127055 A1
(43) Pub. Date: Jun. 7, 2007

(54) INFORMATION PROCESSING APPARATUS AND INFORMATION PROCESSING METHOD

(75) Inventors: Yasuhiro Kujirai, Tokyo (JP); Hiroshi Oomura, Tokyo (JP); Yoshihiro Takagi, Tokyo (JP); Tatsuro Uchida, Tokyo (JP); Masanori Aritomi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/564,740

(22) Filed: Nov. 29, 2006

(30) Foreign Application Priority Data
Dec. 1, 2005 (JP) 2005-348251
Nov. 1, 2006 (JP) 2006-297991

(51) Int. Cl. G06K 15/00

(52) U.S. Cl. 358/1.14; 382/100

(57) ABSTRACT

A content of a copy-forgery-inhibited pattern is set properly each time printing is performed without being influenced by an arbitrary decision by a user. A confidentiality level defined for a document of an image to be printed is acquired. Subsequently, style information indicating a property of the copy-forgery-inhibited pattern assigned to the confidentiality level is acquired. If a property of the copy-forgery-inhibited pattern assigned to the confidentiality level is found, information indicating the found property of the copy-forgery-inhibited patterns is stored as copy-forgery-inhibited pattern property information, and printing is performed in accordance with the assigned property of the copy-forgery-inhibited pattern. On the other hand, if no property of the copy-forgery-inhibited pattern is defined for the document, printing is performed in accordance with a current property of the copy-forgery-inhibited pattern.

### BACKGROUND OF THE INVENTION

1. Field of the Invention

The present invention relates to a process of adding copy-forgery-inhibited pattern data.

2. Description of the Related Art

It is known to print content such as a form document or a resident card on special paper called copy protection paper which has been subjected to special printing to prevent or restrain an original material from being copied. In an original material, an image printed on copy protection paper is difficult for human eyes to perceive. However, if the original material is copied, a character string such as “Copied” appears on a copied material. This makes it possible to easily distinguish a copied material from an original material. This causes a person who has copied the original material to hesitate to use the copied material. By letting the public know that form documents or the like are printed on copy protection paper, it is possible to cause persons to hesitate to copy form documents or the like. However, a problem with copy protection paper is its high cost compared with plain paper. Another problem is that only a character string preprinted on copy protection paper during production of the copy protection paper appears on a copied material. This limits use of the copy protection paper. Specific examples of techniques associated with copy protection paper can be found, for example, in U.S. Pat. No. 5,788,285 or U.S. Pat. No. 6,000,728.

Nowadays, various kinds of contents such as form documents, resident cards, etc. are produced in digital form. However, in many cases, at present, contents produced by computer are not used as digital data but they are used to print on plain paper using a printer.

In recent years, great advances in performance of printers have been made, and it has become possible to achieve copy protection effects not by using copy protection paper but by using a computer and a printer (see, for example, Japanese Patent Laid-Open No. 2001-197297). In this technique, when a content produced using a computer is printed, a copy protection pattern (hereinafter, also referred to as a copy-forgery-inhibited pattern) is superimposed on the background of the content. The copy-forgery-inhibited pattern image on an original material (produced by using a printer) is perceived by human eyes as a simple pattern. However, if the original material is copied, a particular character string or the like appears on the copied material. Therefore, this feature of the original material restrains the original material from being copied, as with the special copy protection paper described above.

When a copy-forgery-inhibited pattern image produced using a computer is output such that the copy-forgery-inhibited pattern image is superimposed on content data, it is possible to use ordinary paper on which to output the copy-forgery-inhibited pattern image, and thus this technique is advantageous in terms of cost compared with the technique using forgery-protected paper. Furthermore, because it is allowed to produce a copy-forgery-inhibited pattern image when content data is printed, it is possible to freely determine a character string or the like which will be visualized when an original printed material is copied. Another advantage is that a character string is not limited to a predetermined one such as “COPIED” but an arbitrary character string such as a user name or a date/time may be used.

As described above, if an original printed material including a copy-forgery-inhibited pattern image is copied, a particular character string or an image appears in a visible form on the copied material, whereby it is possible to suppress use of the copied material. To achieve the above effects, a copy-forgery-inhibited pattern image used herein basically includes two areas: a first area which is included in an original material and which will remain in a copied material; and a second area which is also included in the original material but which will disappear or will become low in intensity on the copied material compared with the intensity of the image in the first area. The dots in these two areas are similar in density on an original printed material and thus, macroscopically, it is difficult to perceive an embedded character string such as “COPIED”, which will appear in a visible form on a copied material. However, microscopically, dots are different between the two areas as described below. A hidden image of a character string or the like which appears when an original material is copied is called a “latent” image, and an image which disappears or becomes low in intensity on a copied material is called a “background” image. Thus, a copy-forgery-inhibited pattern image basically includes a latent mark image and a background image. In some cases, a copy-forgery-inhibited pattern image further includes a camouflage image as will be described later. Note that the latent mark is also referred to as a foreground image, for example, when a user interface is discussed.

In the latent (foreground) image area, dots are formed in the shape of clusters so that dots remain on a copied material. On the other hand, in the background image area, dots are formed at dispersed locations so that dots disappear or an image intensity becomes low on a copied material. Note that dots are formed so that there is no difference in the macroscopic density between the foreground and background areas.

Note that printing of the copy-forgery-inhibited pattern does not necessarily need to be performed in the above-described manner, but the copy-forgery-inhibited pattern may be formed in another manner as long as a character string such as “COPIED” or the like appears in a form visible by a user when an original material is copied. For example, a character string or the like may be formed as a background area with dots which disappear on a copied material so that the character string appears in an open shape (void shape) as a result of disappearing of the dots. Note that in this case, the purpose of the copy-forgery-inhibited pattern printing is also achieved.

FIG. 34 shows an example of a copy-forgery-inhibited pattern image having a latent mark area and a background area. As shown in FIG. 34, dots are dispersed in the background area, while dots are formed in the shape of clusters. The dots in these two areas can be formed using a halftone dot method under different conditions or a dither method under different conditions. For example, when a copy-forgery-inhibited pattern image is produced using the halftone dot method, it is desirable that a latent mark area be produced using a small line density, while a background area be produced using a large line density. In the case in which the dither method is used, it is desirable that a latent mark area be produced using a dot-concentrated dither matrix, while a background area be produced using a dot-dispersed dither matrix.

In general, copiers have a limitation on the reproduction ability depending on the input resolution of detecting small dots on a document or the output resolution of forming small dots on paper. The background area of the copy-forgery-inhibited pattern image is formed of dots with a size smaller than the lower resolution limit of the copier, and the latent mark area is formed of dot clusters with a size greater than the lower resolution limit of the copier so that the latent mark area with dot clusters with the large size is reproduced on a copied material while the background area with the dots with the small size is not reproduced on the copied material and thus the latent image is visualized. Note that small-sized dots of the background area do not necessarily need to completely disappear on a copied material. Even when dots of the background area are reproduced on a copied material, if the density is lower than that of large-sized dot clusters of the latent mark area on the copied material, the latent mark area is converted into a clear visible image.

FIGS. 35A and 35B show a manner in which a latent mark is visualized. That is, FIG. 35A shows an original printed image of a copy-forgery-inhibited pattern, and FIG. 35B shows an image obtained by copying the original image shown in FIG. 35A. From these figures, it can seen that a latent mark with dot clusters is visualized on a copied material while a background image with dispersed dots disappears on the copied material.

It is known to use a camouflaging technique to make a latent image difficult to perceive. In the camouflaging technique, a pattern with a density different from that of the latent mark area and that of the background area is formed over the entire area of an copy-forgery-inhibited pattern image so that a perceivable camouflage image is formed on an original material and the presence of the camouflage image makes it difficult to perceive the latent mark. For example, a copy-forgery-inhibited pattern image including a camouflage image may be formed as a decorative pattern. FIG. 36A shows an example of a copy-forgery-inhibited pattern image including no camouflage image, and FIG. 36B shows an example of a copy-forgery-inhibited pattern image including a camouflage image. It is desirable that the camouflage image disappear on a copied material so that the latent mark is visualized in a form easily perceivable by human eyes. This can be achieved, for example, by forming the camouflage image with void areas in which there are no dots as in the example shown in FIG. 36B.

In general, a user is allowed to arbitrarily make a decision as to whether a copy-forgery-inhibited pattern image is applied to an image to be printed. More specifically, the user is allowed to determine whether to embed a copy-forgery-inhibited pattern image in an image to be printed of a job on a job-by-job basis, and is also allowed to determine the property of the copy-forgery-inhibited pattern image. However, for users, it is troublesome to determine whether to apply a copy-forgery-inhibited pattern image to an image to be printed of a job on a job-by-job basis and/or determine the property of the copy-forgery-inhibited pattern image. Besides, when users are allowed to determine whether to apply a copy-forgery-inhibited pattern image to an image to be printed of a job on a job-by-job basis, there is a possibility that no copy-forgery-inhibited pattern image is applied to an image such as a confidential document which is desirable to have a copy-forgery-inhibited pattern image. Conversely, there is a possibility that an improper copy-forgery-inhibited pattern image is applied to an image to be printed in accordance with an intention of a user. This can cause the image to have a security problem.

One method to avoid the above problems is not to allow a user to make setting associated with printing of a copy-forgery-inhibited pattern but to automatically make setting by a printer driver.

However, this technique still has the following problems, if the property of the copy-forgery-inhibited pattern is automatically set regardless of users and/or regardless of printers. That is, depending on an image to be printed or depending on a user of a printing system, a copy-forgery-inhibited pattern image is unnecessarily embedded in the image or an improper copy-forgery-inhibited pattern image is embedded in the image.

More specifically, there is a possibility that a copy-forgery-inhibited pattern is applied even to a document which is low in confidentiality level and thus does not need to have the copy-forgery-inhibited pattern. In this case, application of the copy-forgery-inhibited pattern can cause the document to become ugly in its appearance. In a case in which an improper image is embedded as copy-forgery-inhibited pattern in a document, there is a possibility that the copy-forgery-inhibited pattern applied to the document cannot functions as the copy-forgery-inhibited pattern.

The type of copy-forgery-inhibited pattern to be embedded in a document can vary depending on a user of a printing system. However, the automatic setting described above does not allow modifications depending on users. Even when a user does not want to embed any copy-forgery-inhibited pattern in a document, a copy-forgery-inhibited pattern is automatically embedded in the document against the intention of the user.

### SUMMARY OF THE INVENTION

In view of the above, it is desirable to properly set a property associated with printing of a copy-forgery-inhibited pattern each time printing is executed, not according to an unreasonable and arbitrary decision of a user but according to a predetermined reasonable rule.

According to an aspect of the present invention, there is provided an information processing apparatus adapted to control printing of copy-forgery-inhibited pattern data embedded in document data, including a defining unit configured to define a confidentiality level, according to which to determine content of a copy-forgery-inhibited pattern, commonly to a plurality of document data such that it is allowed to change the confidentiality level of each document data as required, a copy-forgery-inhibited pattern setting unit configured to, when one of the plurality of document data is specified, set the content of the copy-forgery-inhibited pattern to be embedded in the specified document data in accordance with a confidentiality level defined for the specified document data, and a control unit configured to control printing in accordance with the specified document data and the content of the copy-forgery-inhibited pattern set by the copy-forgery-inhibited pattern setting unit.

According to another aspect of the present invention, there is provided a method of controlling printing such that copy-forgery-inhibited pattern data is embedded in document data. The method includes defining a confidentiality level, according to which to determine a content of a copy-forgery-inhibited pattern, commonly to a plurality of document data such that it is allowed to change the confidentiality level of each document data as required, when one of the plurality of document data is specified, setting the content of the copy-forgery-inhibited pattern to be embedded in the specified document data in accordance with a confidentiality level defined for the specified document data, and controlling printing in accordance with the specified document data and the content of the copy-forgery-inhibited pattern set for the specified document data.

Other features and advantages of the present invention will be apparent from the following description taken in conjunction with the accompanying drawings, in which like reference characters designate the same or similar parts throughout the figures there.

### BRIEF DESCRIPTION OF THE DRAWINGS

FIG. 1 is a block diagram showing a configuration of a printing system according to an embodiment of the present invention.

FIG. 2 is a diagram showing an example of a configuration of a computer for performing a printing process according to an embodiment of the present invention.

FIG. 3 shows an example of an extended configuration of a host computer adapted to perform a printing process according to an embodiment of the present invention.

FIG. 4 is a flow chart showing a process performed by a spooler to store data in units of pages in a spool file according to an embodiment of the present invention.

FIG. 5 is a flow chart showing a process performed by a spool file manager to produce a spool file and a process of producing print image data according to an embodiment of the present invention.

FIG. 6 is a flow chart showing the details of a process performed by a despooler to produce print image data according to an embodiment of the present invention.

FIG. 7 is a diagram showing an example of a dialog screen for setting a print property according to an embodiment of the present invention.

FIG. 8 is a diagram showing an example of a setting screen which allows a user to specify an output destination of a print job according to an embodiment of the present invention.

FIG. 9 is a diagram showing an example of a data format of information sent together with a physical page print request from a spool file manage to a despooler according to an embodiment of the present invention.

FIG. 10 is a diagram showing an example of job setting information described in a field in FIG. 9 according to an embodiment of the present invention.

FIG. 11 is a diagram showing an example of a data format of information sent together with a physical page print request from a spool file manage to a despooler according to an embodiment of the present invention.

FIG. 12 is a diagram showing an example of physical page setting information described in a field shown in FIG. 11 according to an embodiment of the present invention.

FIG. 13 is a diagram showing an example of a data format of information sent together with a physical page print request from a spool file manage to a despooler according to an embodiment of the present invention.

FIG. 14 is a diagram showing an example of a data format of additional print information described in a field shown in FIG. 12 according to an embodiment of the present invention.

FIG. 15 is a diagram showing an example of a setting screen which allows a user to set a property of printing of a copy-forgery-inhibited pattern according to an embodiment of the present invention.

FIGS. 16A and 16B show examples of dialog screens for setting the details of the property of printing a copy-forgery-inhibited pattern.

FIG. 17 is a flow chart showing an example of a process of rendering a copy-forgery-inhibited pattern according to an embodiment of the present invention.

FIG. 18 is a flow chart showing an example of a process of rendering a copy-forgery-inhibited pattern according to an embodiment of the present invention.

FIG. 19 is a flow chart showing the details of the process of rendering a copy-forgery-inhibited pattern according to an embodiment of the present invention.

FIG. 20 is a flow chart showing a process of setting a property of printing of a copy-forgery-inhibited pattern depending on a confidentiality level of an image such as a document image to be printed, according to an embodiment of the present invention.

FIG. 21 is a flow chart showing a document management process associated with a process, in a step shown FIG. 20, of acquiring confidentiality level information of a document, according to an embodiment of the present invention.

FIG. 22 shows an example of a data format of information indicating confidentiality levels defined for respective documents, according to an embodiment of the present invention.

FIG. 23 shows an example of a data format of information indicating the correspondence between confidentiality levels and styles of a copy-forgery-inhibited pattern, according to an embodiment of the present invention.

FIG. 24 shows an example of a user interface which allows a user to define the correspondence between confidentiality levels and styles of a copy-forgery-inhibited pattern according to an embodiment of the present invention.

FIG. 25 shows an example of a setting screen which allows a user to set the confidentiality level for each document according to an embodiment of the present invention.

FIG. 26 is a flow chart showing a process of setting the property of printing of a copy-forgery-inhibited pattern depending on user information in accordance with an embodiment of the invention.

FIG. 27 shows an example of a data format of information indicating the correspondence between user information and styles of a copy-forgery-inhibited pattern according to an embodiment of the present invention.

FIG. 28 shows an example of a user interface which allows a user to define the correspondence between user information and styles of a copy-forgery-inhibited pattern according to an embodiment of the present invention.

FIG. 29 is a diagram showing an example of a setting screen which allows a user to set a property of printing of a copy-forgery-inhibited pattern according to an embodiment of the present invention.

FIG. 30 is a diagram showing an example of a dialog screen which allows a user to define a new correspondence between user information and a style of a copy-forgery-inhibited pattern according to an embodiment of the present invention.

FIG. 31 is a flow chart showing a process of setting a property of printing of a copy-forgery-inhibited pattern depending on a confidentiality level of an image such as a document image to be printed, according to an embodiment of the present invention.

FIG. 32 is a flow chart showing a process performed by a client computer according to an embodiment of the present invention.

FIG. 33 shows an example of a data format of information defining correspondences among documents, confidentiality levels, and exceptional users according to an embodiment of the present invention.

FIG. 34 shows an example of a copy-forgery-inhibited pattern image having a latent mark area and a background area.

FIGS. 35A and 35B show a manner in which a latent mark is visualized.

FIG. 36A shows an example of a copy-forgery-inhibited pattern image having no camouflage image, and FIG. 36B shows an example of a copy-forgery-inhibited pattern image having a camouflage image.

### DESCRIPTION OF THE EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

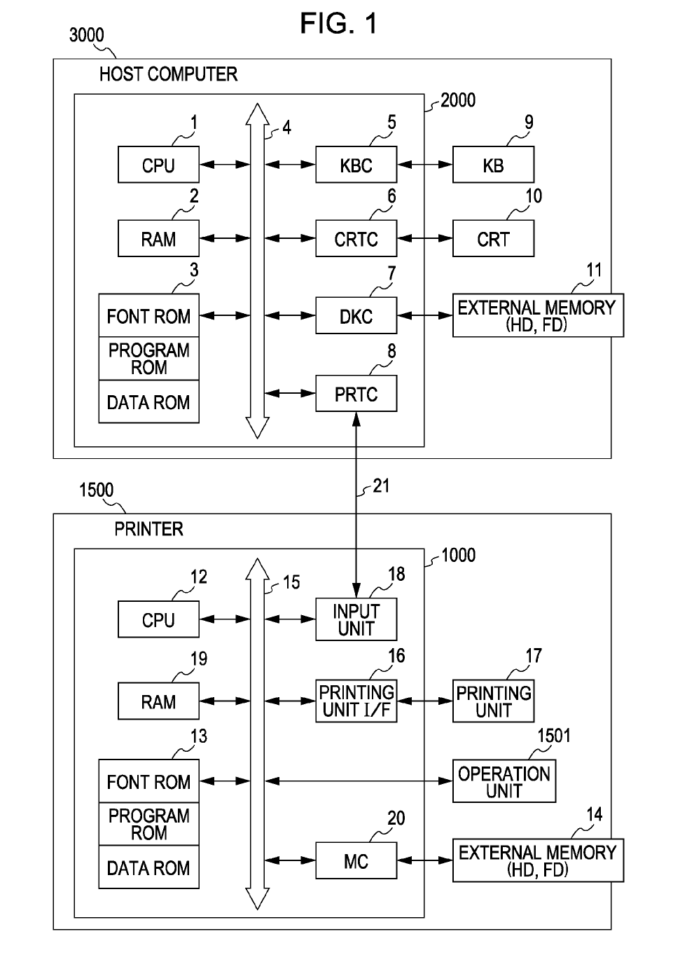

Referring to FIGS. 1 to 19, a configuration of a system including an information processing apparatus serving as a host computer and a printer serving as a printing apparatus, a printing process, and a process of producing basic print data of a copy-forgery-inhibited pattern according to an embodiment of the present invention are described below.

In the present embodiment, a part of a copy-forgery-inhibited pattern which is visualized when an original material is copied is referred to as a latent mark area or a foreground area, and a part which disappears or becomes low in density compared with the density of the latent mark area is referred to as a background area. Text information such as “INVALID” or “VOID” is described in the latent mark area. Note that in the present invention, the copy-forgery-inhibited pattern image is not limited to the above-described type. For example, a copy-forgery-inhibited pattern image may be formed such that a character string appears in an open shape (void shape) on a copied material. In this case, a latent mark area and a background area are formed in an opposite manner in terms of concentrated and dispersed dots to the manner in which a latent mark area appears in a normal form on a copied material. Also note that in the present invention, there are no particular restrictions on the type, the color, the shape, the size, and the like of the copy-forgery-inhibited pattern image. There is also no restriction on the process of producing the copy-forgery-inhibited pattern image.

Configuration of Printing System

Referring to FIG. 1, a configuration of a printing system according to an embodiment of the present invention is described. Note that the present invention may be applied not only to such a system shown in FIG. 1 but also to a single device or apparatus, a system including a plurality of devices or apparatus installed at the same location, or a system including a plurality of devices or apparatus which are installed at different locations and which are connected via a network such as a LAN or a WAN.

As shown in FIG. 1, a host computer 3000 includes a CPU 1 that performs various processes according to one of embodiments described below in accordance with programs such as a document processing program stored in a program ROM area of a ROM 3 or stored in an external memory 11. The processes performed by the CPU 1 include processing of a document including a graphic image, a photographic image, text, a table (such as a spreadsheet), etc. and a process of printing such a document. The CPU 1 is responsible for general control of devices connected to a system bus 4. In the program ROM area of the ROM 3 or in the external memory 11, there is also stored an operating system (OS) as one of control programs according to which the CPU 1 operates. Data such as font data for use in processing of documents is stored in a font ROM area of the ROM 3 or in the external memory 11, and other various kinds of data used in processing of documents are stored in a data ROM area of the ROM 3 or in the external memory 11. A RAM 2 is used by the CPU 1 as a main memory or a work area.

A keyboard controller (KBC) 5 controls a key input operation of a keyboard 9 or a pointing device (not shown). A CRT controller (CRTC) 6 controls a displaying operation of a CRT display 10. Note that displaying of a copy-forgery-inhibited pattern image on the CRT display 10 is also controlled by the CRT controller 6. A disk controller (DKC) 7 controls a hard disk (HD) on which there are stored a boot program, various kinds of application program, font data, user files, a file being edited, a printer control command generation program (hereinafter referred to as a printer driver), etc. The disk controller 7 also controls an access operation to the external memory 11 such as a floppy (registered trademark) disk (FD). A printer controller (PRTC) 8, which is connected to a printer 1500 via a bidirectional interface 21, is responsible for control of communication with the printer 1500. More specifically, the printer controller 8 controls the transmission of print job data, various request data, various response data from the printer, etc.

For example, the CPU 1 rasterizes outline font data in a display information area of the RAM 2 thereby making it possible to display information on the CRT 10 in a WYSIWYG manner. In accordance with commands issued by clicking icons or the like displayed on the CRT 10 with a mouse cursor or the like, the CPU 1 opens various kinds of windows and performs various kinds of data processing. When a printing operation is performed, a user is allowed to open a window for setting printing conditions and set the printer driver in terms of printing conditions including printer setting and the printing mode.

The printer 1500 is controlled by a CPU 12 disposed therein. In accordance with a control program stored in the program ROM area of the ROM 13 or a control program stored in an external memory 14, the CPU 12 outputs an image signal as print output information to a printing unit (printer engine) 17 connected to a system bus 15 via a printing unit I/F 16. The ROM 13 includes the program ROM area in which the control program executed by the CPU 12 is stored. The ROM 13 also includes a font ROM area in which font data for use in producing the print output information is stored. When the printer used does not have a hard disk or the like serving as the external memory 14, information used by the host computer 3000 is stored in a data ROM area of the ROM 13.

The CPU 12 is capable of communicating with the host computer 3000 via an input unit 18. This allows it to transmit information from the printer 1500 to the host computer 3000. A RAM 19 is used by the CPU 12 as a main memory or a work area. The storage capacity of the RAM 19 may be extended by connecting an optional RAM to an extension port (not shown). The RAM 19 is also used as an output information rendering area, an environment data storage area, a NVRAM, etc. Accessing to the above-described external memory 14 such as the hard disk (HD) or the IC card is controlled by a memory controller (MC) 20. The external memory 14 is optionally connected to store font data, an emulation program, form data, etc. An operation panel 1501 is used by a user to input a command/data and includes switches and LED indicators.

The number of external memories 14 is not limited to one, but there may be provided a plurality of external memories 14 for storing not only standard font data but also a program of interpreting various kinds of printer control languages. The printer 1500 may also include a NVRAM (not shown) to store printer mode setting information input via the operation panel 1501.

In the present embodiment, the printing unit 17 is an electrophotographic engine capable of printing an image by forming dots in accordance with print image data. Note that the present invention is not limited to the electrophotographic printing method, and other types of printing methods may also be used. For example, the present invention may also be applied to any type of printing apparatus adapted to perform printing by forming dots, such as an ink-jet printer.

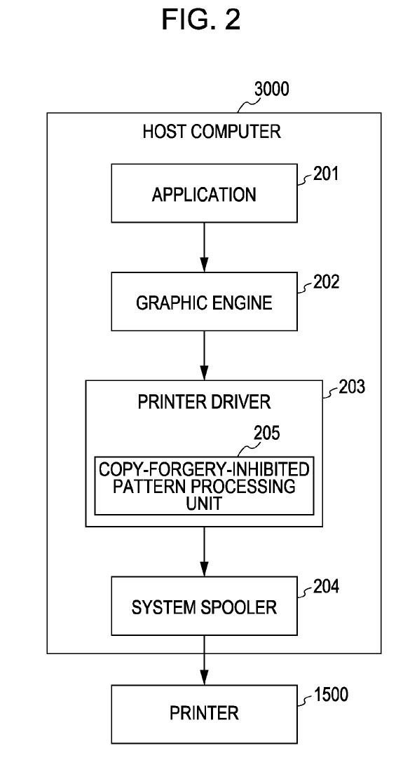

FIG. 2 shows an example of a configuration of the host computer 3000 shown in FIG. 1 for performing a printing process according to an embodiment of the present invention. In FIG. 2, an application program 201, a graphic engine 202, a printer driver 203, and a system spooler 204 are program modules stored in the form of files in the external memory 11. These program modules are loaded by an operation system (OS) or a module using the OS from the external memory 11 into the RAM 2, and the program modules are executed by the CPU 1. The application program 201 and the printer driver 203 a floppy disk or a CD-ROM (not shown) serving as the external memory 11 or may be loaded into a hard disk or the like serving as the external memory 11 via a network (not shown). The application 201 stored in the external memory 11 is loaded into the RAM 2 and executed. When the application 201 performs a printing process using the printer 1500, outputting (rendering) is performed using the graphic engine 202 which is also loaded in the RAM 2.

The graphic engine 202 loads one of printer drivers 203 prepared for respective printing apparatus (printers) from the external memory 11 into the RAM 2 and transfers data output from the application 201 to the printer driver 203. If the graphic engine 202 receives GDI (Graphic Device Interface) functions from the application 201, the graphic engine 202 converts the received GDI functions into DDI (Device Driver Interface) functions and outputs them to the printer driver 203. If the printer driver 203 receives the DDI functions from the graphic engine 202, the printer driver 203 converts the received DDI functions into control commands such as PDL (Page Description Language) commands which can be handled by the printer. The resultant printer control commands are output as print data to the printer 1500 via the system spooler 204 loaded by the OS in the RAM 2 and further via the interface 21.

In the present embodiment, the printing system includes a copy-forgery-inhibited pattern processing unit 205 in the printer driver 203. The copy-forgery-inhibited pattern processing unit 205 may be a build-in module of the printer driver 203 or may be a library module which is separately installed. When a copy-forgery-inhibited pattern image is printed, the printer driver 203 performs processing including rendering of the copy-forgery-inhibited pattern image by using the copy-forgery-inhibited pattern processing unit 205.

Software Modules for Printing

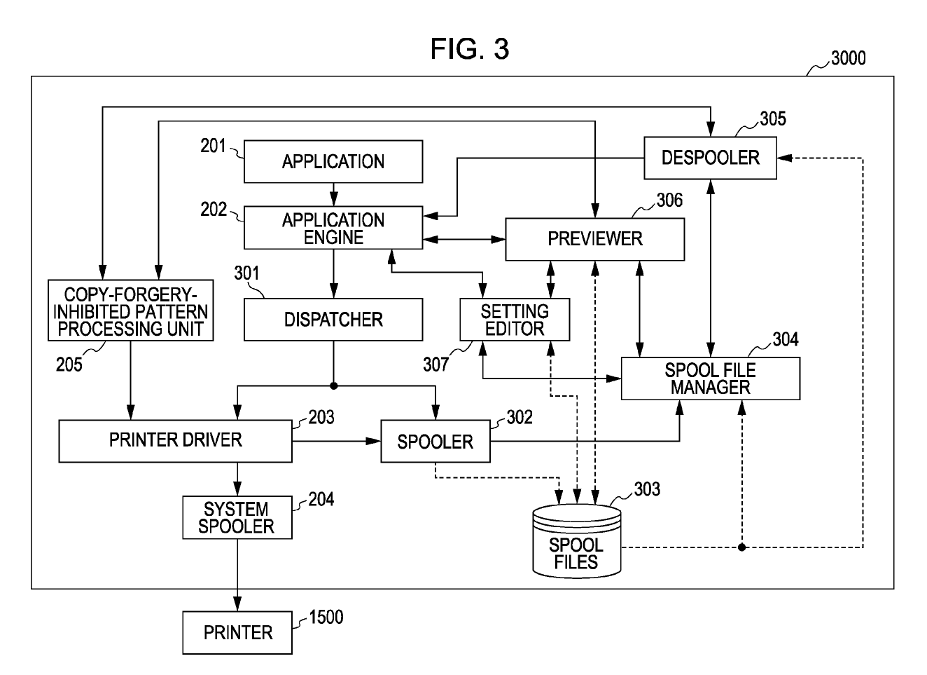

FIG. 3 shows another example of a configuration of the host computer 3000 adapted to perform a printing process according to an embodiment of the present invention. This configuration is based on that shown in FIG. 2 and is extended such that when print commands are sent from the graphic engine 202 to the printer driver 203, the print commands are converted into intermediate codes and stored in a spool file 303. In the configuration described above with reference to FIG. 2, the application 201 is not released from the printing process until the printer driver 203 has converted all print commands received from the graphic engine 202 into printer control commands. In contrast in the configuration shown in FIG. 3, the application 201 is released from the printing process when the spooler 302 has converted all print commands into intermediate code data and has output the resultant intermediate code data to the spool file 303. In general, the configuration shown in FIG. 3 allows the application 201 to be released from the printing process earlier than that shown in FIG. 2 allows. Furthermore, the configuration shown in FIG. 3 allows it to process the content of the spool file 303. This makes it possible to realize functions which are not provided by the application, such as zooming, printing a plurality of logical pages on one physical page, etc. For the above purpose, as shown in FIG. 3, the present system has the configuration extended from that shown in FIG. 2 so as to have the capability of spooling data in the form of intermediate code data. In general, to process print image data, setting is performed via a window provided by the printer driver 203, and data indicating the setting is stored by the printer driver 203 in the RAM 2 or the external memory 11.

First, the configuration shown in FIG. 3 is explained in detail below. In the extended process, as can be seen from FIG. 3, a DDI function is sent as a print command from a graphic engine 202 to a dispatcher 301. In some cases, the print command (DDI function) supplied from the graphic engine 202 to the dispatcher 301 is based on a print command (GDI function) issued by the application 201 to the graphic engine 202. In this case, the dispatcher 301 loads the spooler 302 from the external memory 11 into the RAM 2, and the dispatcher 301 sends print commands (DDI functions) not to the printer driver 203 but to the spooler 302.

The spooler 302 analyzes the received print commands and converts them into intermediate codes in units of pages. The resultant intermediate codes are output to the spool file 303. The spool file in which the intermediate codes are written in units of pages are called a page description file (PDF). The spooler 302 acquires from the printer driver 203 information indicating processing conditions (such as a N-up printing mode, a two-sided printing mode, finishing such as stapling, a color/monochrome mode, etc.) associated with the print image data set in the printer driver 203. The acquired information is stored in units of jobs in the spool file 303. This setting file stored in units of jobs is called a job setting file (or a spool description file (SDF)). The details of the job setting file will be described later. Although in the present embodiment, the spool file 303 is produced in the external memory 11, it may be produced in the RAM 2. The spooler 302 loads a spool file manager 304 from the external memory 11 into the RAM 2 and notifies the spool file manager 304 of the status in terms of the production of the spool file 303. The spool file manager 304 determines whether it is ready to start printing, on the basis of the process setting associated with the print image data stored in the spool file 303.

If the spool file manager 304 determines that it is ready to start printing using the graphic engine 202, the spool file manager 304 loads a despooler 305 from the external memory 11 into the RAM 2, and requests the despooler 305 to perform printing according to the intermediate code described in the page description file stored in the spool file 303.

The despooler 305 processes the intermediate code described in the page description file stored in the spool file 303 in accordance with the job setting file including process setting information stored in the spool file 303 to reproduce a GDI function, and outputs the resultant GDI function via the graphic engine 202. In this process, the copy-forgery-inhibited pattern processing unit 205 is loaded and rendering of the copy-forgery-inhibited pattern image is performed by the copy-forgery-inhibited pattern processing unit 205. That is, in the present embodiment, the copy-forgery-inhibited pattern processing unit 205 performs processing associated with printing of the copy-forgery-inhibited pattern image in cooperation with the despooler 305 and the spool file manager 304. The processing performed herein includes producing of commands associated with the copy-forgery-inhibited pattern image as will be described later.

Note that the copy-forgery-inhibited pattern processing unit 205 may be a build-in module of the printer driver 203 or may be a library module which is separately installed.

If the print command (DDI function) that the dispatcher 301 has received from the graphic engine 202 is based on the print command (GDI function) issued from the despooler 305 to the graphic engine 202, the dispatcher 301 sends the print command not to the spooler 302 but to the printer driver 203. The printer driver 203 produces a printer control command described, for example, in a page description language or the like on the basis of the DDI function acquired from the graphic engine 202, and outputs it to a printer 1500 via the system spooler 204.

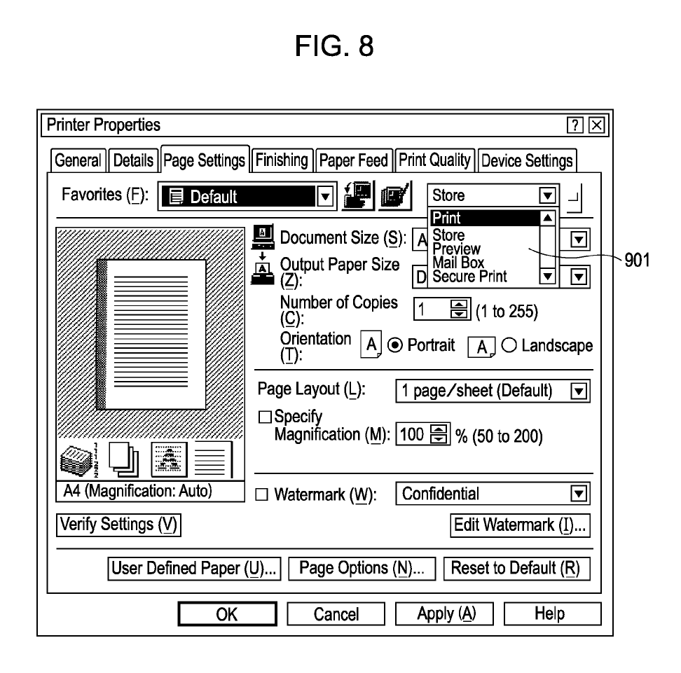

In the example of the configuration shown in FIG. 3, the configuration has further functional units that allow further capabilities in addition to the extended capabilities described above. More specifically, the configuration includes a previewer 306 and a setting editor 307 that allow previewing of an image to be printed including a copy-forgery-inhibited pattern image, setting of printing conditions, and combining of a plurality of jobs. To preview an image to be printed, change print settings, and/or combine a plurality of jobs, a user first designates “Store” in a pull-down menu 901 given as a means for specifying “output destination” in the properties of the printer driver, which will be described in further detail below with reference to FIG. 8. When the user wants to see only a preview image, he/she may select “Preview” as the output destination.

Note that the data indicating the properties of the printer driver is stored as a setting file in the form of a structure provided by an operating system (in the case of a Windows (trademark) operating system, such a structure is called DEVMODE). The information stored in this structure also includes, for example, information specifying whether to store data in the spool file manage 304 as one of items associated with the setting of the spool file 303. When the spool file manager 304 reads process setting data via the printer driver, if it is determined that “Store” is specified in the process setting data, then a page description file and a job setting file are produced and stored in the spool file 303 in the above-described manner. The spool file manage 304 then displays a pop-up window screen on which a list of jobs spooled in the spool file 303 is displayed.

On this pop-up window screen, if previewing of a single job or merged jobs is specified, the spool file manager 304 loads the previewer 306 from the external memory 11 into the RAM 2 and displays, on the previewer 306, a preview image of the specified job in accordance with the intermediate codes described in the spool file 303.

Storing of Intermediate Print Data

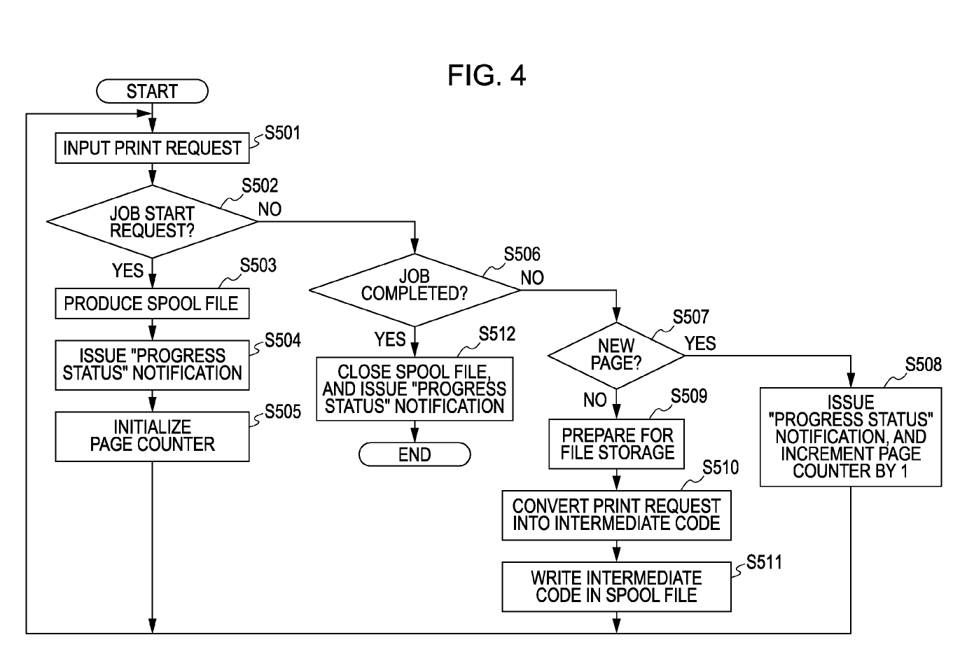

FIG. 4 is a flow chart showing a process performed by the spooler 302 to store data in units of pages in the spool file 303 according to an embodiment of the present invention.

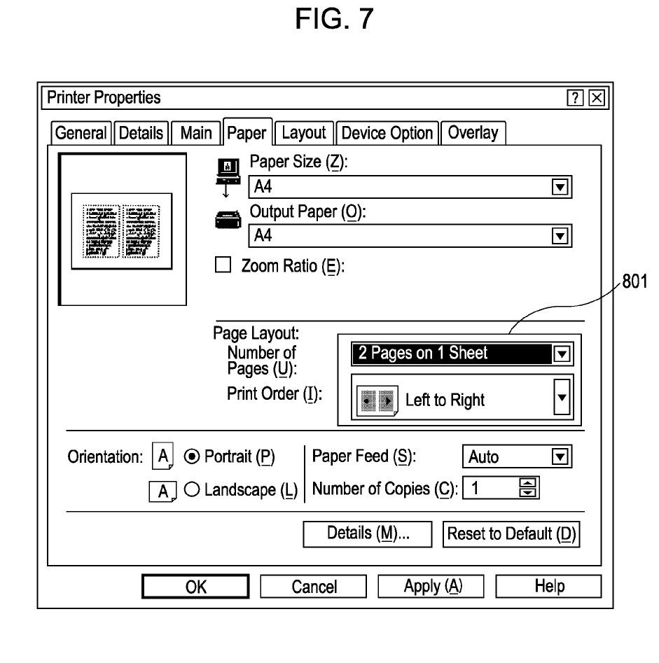

First, in step S501, the spooler 302 receives a print request from an application via the graphic engine 202. In response to the request from the application, a dialog for making print settings such as that shown in FIG. 7 is displayed, and data indicating the print settings made via this dialog is transferred from the printer driver to the spooler 302. The setting input dialog shown in FIG. 7 includes a setting box 801 that allows a user to specify the number of logical pages to be laid out on one physical page.

In step S502, the spooler 302 determines whether the received print command is a “start job” command. If it is determined in step S502 that the received command is the “start job” command, the processing flow proceeds to step S503, in which the spooler 302 creates the spool file 303 for temporarily storing intermediate data. In step S504, the spooler 302 notifies the spool file manager 304 of the status of the print process. In step S505, the spooler 302 initializes a page counter to 1. In response, the spool file manager 304 reads the information, such as process setting information, associated with the job whose printing operation has been started, from the spool file 303 and stores the read information in the spool file manager 304.

If it is determined in step S502 that the command is not the “start job” command, the processing flow proceeds to step S506. In step S506, the spooler 302 determines whether the received command is an “end job” command. If the spooler 302 determines that the received command is not the “end job” command, the processing flow proceeds to step S507 to determine whether the command is a “new page” command. If it is determined in step S507 that the command is the “new page” command, the processing flow proceeds to step S508 to notify the spool file manager 304 of the status of the print process. The page counter is then incremented, and the page description file in which the intermediate codes are described is closed. A next page description file is then created. If it is determined in step S507 that the received print command is not the “new page” command, the processing flow proceeds to step S509, in which the spooler 302 makes a preparation to write intermediate codes in the page description file.

In step S510, the spooler 302 converts the DDI function of the print command into an intermediate code to be stored in the spool file 303. In step S511, the spooler 302 writes the print command, which has been converted in step S510 into the form of the intermediate code allowed to be stored, into the page description file in the spool file 303. The processing flow then returns to step S501 to receive a next print command from the application. The process from steps S501 to S511 is repeated until an “end job” (End Doc) command is received from the application. Meanwhile, the spooler 302 acquires information such as information indicating the process settings stored in the DEVMODE structure from the printer driver 203, and stores the information as a job setting file in the spool file 303. If it is determined in step S506 that the print command from the application is the “end job” command, it is determined that no more print commands will be sent from the application, and thus the processing flow proceeds to step S512 to notify the spool file manager 304 of the status of the print process. The process is then ended.

Producing of Spool File

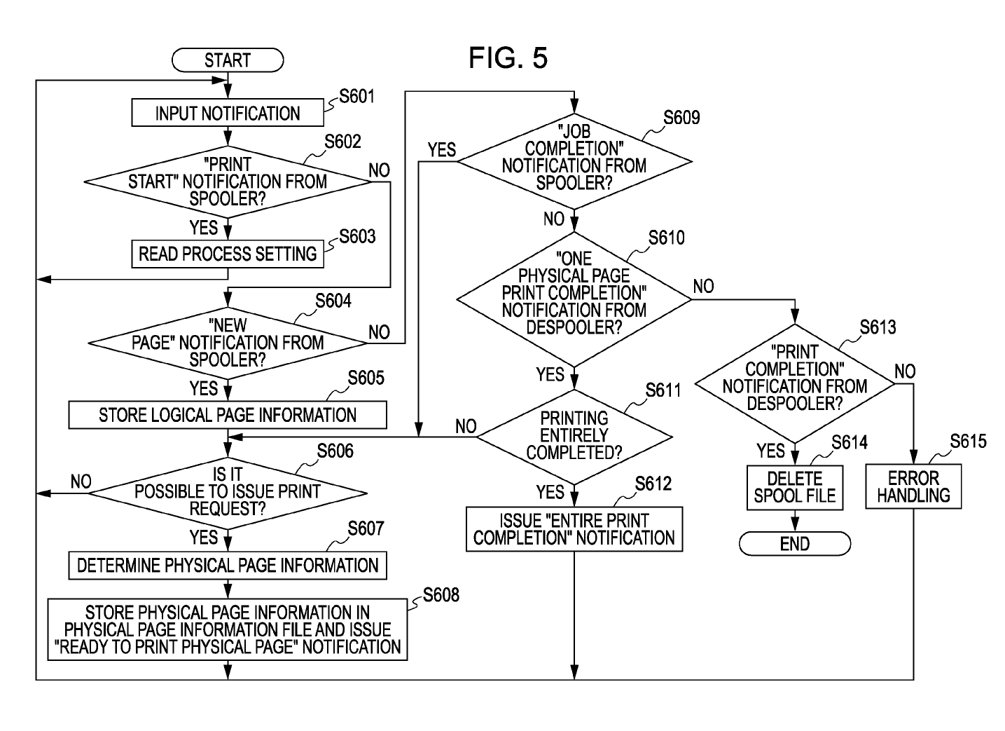

FIG. 5 is a flow chart showing the details of a process performed by the spool file manager 304 according to an embodiment of the present invention. The process show herein includes producing a spool file 303 and producing print image data.

In step S601, the spool file manager 304 receives a notification of the status of the print process from the spooler 302 or the despooler 305. In step S602, the spool file manager 304 determines whether the notification received in step S504 is a print start notification from the spooler 302. If the answer to step S602 is Yes, then the processing flow proceeds to step S603 to read data indicating the print process settings from the spool file 303 and start job management. On the other hand, if it is determined in step S602 that the notification is not a print start notification from the spooler 302, the processing flow proceeds to step S604, in which the spool file manager 304 determines whether the process status notification is a print end notification indicating the end of printing of one logical page issued in step S508 by the spooler 302. If the answer to step S604 is Yes, the processing flow proceeds to step S605. In step S605, logical page information associated with the present logical page is stored. In step S606, it is determined whether it is allowed to start printing of one physical page using n logical pages which have been spooled by this point of time. If the answer to step S606 is Yes, the processing flow proceeds to step S607 to determine the physical page number from the number of logical pages assigned to one physical page to be printed.

More specifically, the calculation of physical pages is performed as follows. For example, when it is specified in the process setting data to lay out four logical pages on one physical page, it becomes possible to start printing of a first physical page when a spooling of a fourth logical page is completed. In this case, it is determined that it is possible to start printing of the first physical page. Subsequently, it becomes possible to start printing of a second physical page when spooling of an eighth logical page is completed. Even if the total number of logical pages is not a multiple of the number of logical pages laid out on one physical page, logical pages to be laid out on one physical page can be determined from the spool end notification issued in step S512.

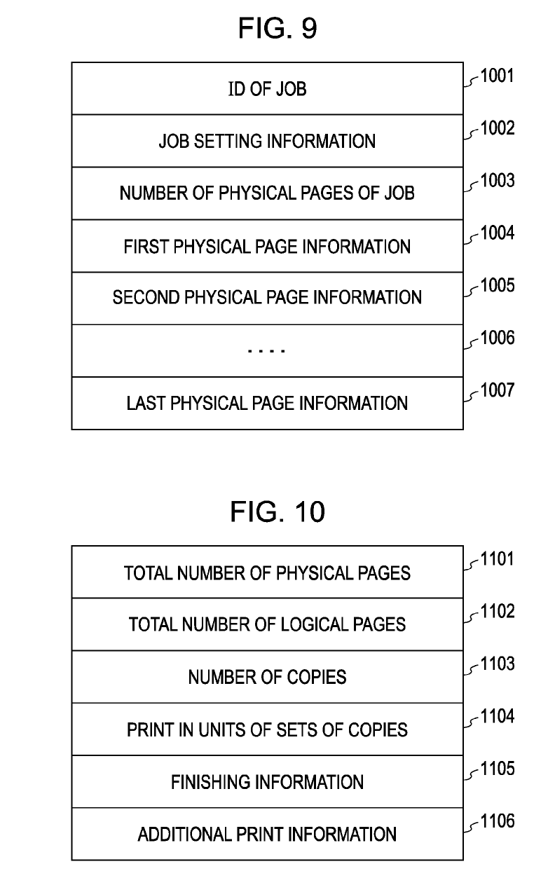

In step S608, a message is sent to notify that information indicating logical pages of a physical page ready to be printed, information indicating the physical page number of that physical page, and other associated information have been stored in the format shown in FIG. 9 in the job output setting file (including physical page information). That is, the despooler 305 is notified that one more physical page of information has been added. The processing flow then returns to step S601 to wait for a next notification. In the present embodiment, it is possible to start the print process when spooling of one page of print image data is completed, that is, when spooling of logical pages to be printed on one physical page is completed, without having to wait for the completion of spooling of all data associated with the present print job.

In the case in which it is determined in step S604 that the process status notification is not a print end notification indicating the completion of printing of one logical page from the spooler 302, the processing flow proceeds to step S609. In step S609, the spool file manager 304 determines whether the notification is the job end notification issued in step S512 from the spooler 302. If the answer to step S609 is Yes, the processing flow proceeds to step S606. If the answer to step S609 is No, the processing flow proceeds to step S610, in which the spool file manager 304 determines whether the received notification is a print end notification indicating completion of printing of one physical page from the despooler 305. If the answer to step S610 is Yes, the processing flow proceeds to step S611 to determine whether printing of all data specified by the process setting data is completed. If the answer to step S611 is Yes, the processing flow proceeds to step S612 to notify the despooler 305 of the completion of printing. However if the answer to step S611 is No, the processing flow proceeds to step S606 described above. Note that in the present embodiment, it is assumed that the despooler 305 is adapted to perform the print process in units of physical pages. In step S608, information required for print processing of one physical page is sequentially stored in a file so that the stored information can be reused. If such information does not need to be reused, a high-speed memory such as a shared memory may be used and the information may be sequentially overwritten therein in units of physical pages thereby achieving an increase in the processing speed and saving the resources. When spooling progresses faster than despooling or when despooling is started after all pages have been spooled, a print-ready notification issued in step S608 for each physical page may be omitted. That is, in this case, a notification indicating that it has become ready to perform a plurality or all of physical pages may be issued depending on the progress of the despooling process. This allows a reduction in the number of times the print-ready notification is issued.

In a case in which it is determined in step S610 that the notification is not a print end notification indicating completion of one physical page from the despooler 305, the processing flow proceeds to step S613, in which the spool file manager 304 determines whether the notification is a print end notification indicating completion of all physical pages from the despooler 305. If the answer to step S613 is Yes, the processing flow proceeds to step S614, in which the spool file manager 304 deletes the corresponding page description file in the spool file 303 and ends the processing. However, if the notification is not a print end notification indicating completion of all physical pages from the despooler 305, the processing flow proceeds to step S615 to perform other processing and wait for a next notification.

Outputting of Spool File

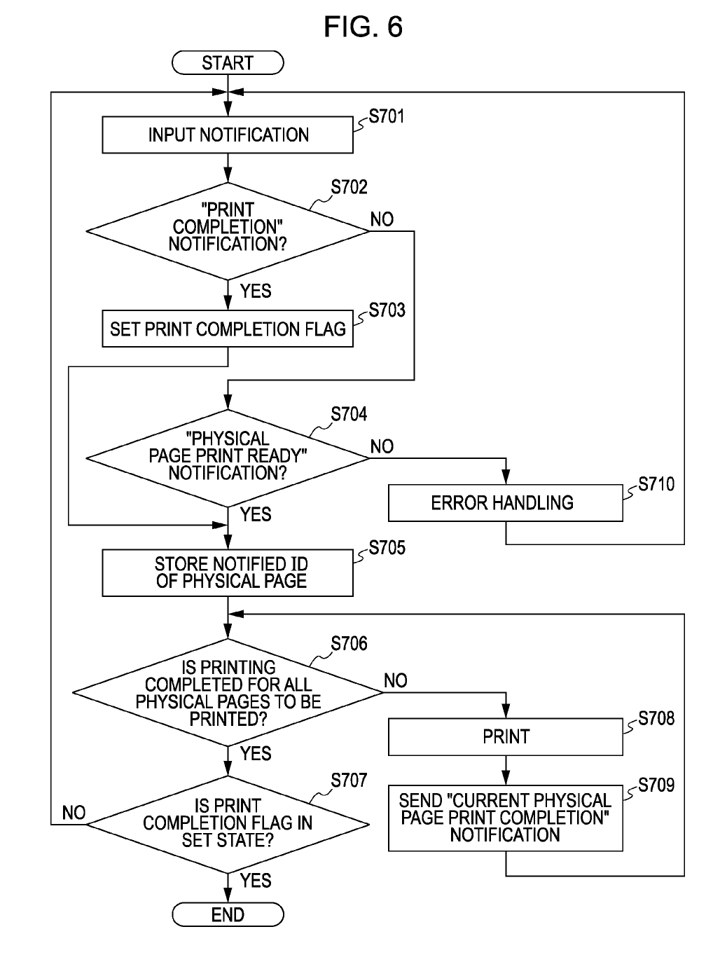

FIG. 6 is a flow chart showing the details of the process performed by the despooler 305 to producing print image according to an embodiment of the present invention.

The despooler 305 reads necessary information (a page description file and a job setting file) from the spool file 303 in accordance with a print command issued by the spool file manager 304, and produces print image data in accordance with the read information. The resultant print image data is transmitted to the printer in a similar manner as described above with reference to FIG. 3. Note that the print image data is described in the PDL (Page Description Language) as described above.

In the process of producing print image data, first in step S701, a notification from the spool file manager 304 is input. In step S702, the despooler 305 determines whether the input notification is a job end notification. If the answer to step S702 is Yes, the processing flow proceeds to step S703 to set an end flag. The processing flow then proceeds to step S705. If it is determined in step S702 that the notification is not the job end notification, the processing flow proceeds to step S704 to determine whether the print start command to print one physical page in step S608 has been issued. If the answer to step S704 is No, the processing flow proceeds to step S710 to perform error handling. The processing flow then returns to step S701 to wait for a next notification. In a case in which it is determined in step S704 that the command is a print start command to print one physical page, the processing flow proceeds to step S705, in which the despooler 305 stores the ID of the physical page to be printed, described in the notification received in step S704. In step S706, the despooler 305 determines whether the print process is completed for all physical pages indicated by IDs stored in step S705. If the answer to step S706 is Yes the flow proceeds to step S707 to determine whether the end flag has been set in step S703. If the answer to step S707 is Yes, it is determined that printing of the current job is completed, and a notification indicating that the process by the despooler 305 is completed is sent to the spool file manager 304. The process is then ended. On the other hand, if it is determined in step S707 that the end flag has not been set, the processing flow returns to step S701 to wait for a next notification. In a case in which it is determined in step S706 that there are more physical pages to be printed, the processing flow proceeds to step S708. In step S708, the despooler 305 sequentially reads the IDs of unprocessed physical pages, reads information required to produce print image data of physical pages indicated by the read physical page IDs, and performs the print process thereon. In the print process, the despooler 305 converts print commands stored in the spool file 303 into form (GDI functions) that allows the graphic engine 202 to deal with, and transfers the resultant data to the graphic engine 202. In the present example, it is assumed that it is specified in the process setting data to print a plurality of logical pages on one physical page (in a N-up page layout). In this case, print commands are converted so that a specified number of logical pages are placed on one physical page. When the print process is completed, the processing flow proceeds to step S709 to notify the spool file manager 304 of the completion of producing of the print image data of one physical page. The processing flow then returns to step S706 to repeat the above-described process until the print process is completed for all physical pages to be printed, indicated by the IDs stored in step S705.

The print process performed by the dispatcher 301, the spooler 302, the spool file manager 304, and the despooler 305 has been described above. In the print process described above, the application 201 is released from the print process when the spooler 302 has produced all intermediate codes and stored them in the spool file 303. Therefore, the application 201 is released earlier than would be released when print image data is directly output to the printer driver 203. Because the print image data is temporarily stored as intermediate files (the page description file and the job setting file) in the spool file 303 according to the print settings of the printer driver, a user is allowed to see a preview image, which allows the user to understand how the print image data will be actually printed. This also allows the user to modify the print settings as required or to combine or rearrange a plurality of print jobs without having to activate the application and print image data.

In the print process using the spooler 302, a job output setting file is produced when the despooler 305 sends a print request to the graphic engine 202. A job output setting file is also produced when the print data is previewed or when a plurality of jobs are combined. Note that the job output setting file is similar to the job setting file when a single job is concerned. When a plurality of jobs are combined, the job output setting file is produced on the basis of original job setting information associated with the respective jobs. The details of the job output setting file are described below.

Configuration of Job Output Setting File

FIG. 9 shows an example of a job output setting file which is produced in step S608 by the spool file manage 304 and in which information associated with physical pages ready to be printed is described. An ID identifying a job is described in a field 1001. A file name of a file or a name of a shared memory in which the job output setting file is stored may be used as the ID. The job setting information is described in a field 1002. The job setting information includes a structure needed by the graphic engine 202 to start printing of the job, information specifying whether printing should be performed in an N-up form, information specifying an additional image such as page frame or the like, information specifying the number of copies, etc. Information specifying finishing such as stapling may also be described in the job setting information. Note that the job setting information 1002 may include as much information as is necessary to process a given job. The number of physical pages is described in a field 1003. In fields following this field 1003, as many pages of physical page information as indicated in the field 1003 are stored. In the present embodiment, because the number of physical pages which have become ready to be printed is notified, the field 1003 is not necessarily needed. Following this field 1003, as described above, physical page information is stored in as many fields as indicated by the data described in field 1003. That is, physical page information is stored in fields from a field 1004 to a final field. The details of physical page information will be described later with reference to FIG. 12.

FIG. 10 shows an example of the job setting information described in the field 1002 shown in FIG. 9. In a field 1101, the total number of physical pages is described. In a field 1102, the total number of logical pages is described. The fields 1101 and 1102 are attached to print image data, for example, when page numbers are printed as additional information on respective pages. When printing is in process, temporary values are stored in these two fields, or alternatively, the spool file manager 304 may postpone producing information of physical pages until the printing process is completed. In a field 1103, information specifying the number of copies to be made for the present job is described. In a field 1104, information is described to specify, when the field 1103 specifies that a plurality of copies are to be printed, whether printing is to be performed in units of sets of copies. The field 1104 is used when finishing such as stapling, punching, or Z-folding or the like is to be performed using a finisher disposed inside or outside the printer. In a field 1106, additional print information to be embedded in the job is stored. For example, copy-forgery-inhibited pattern information, a page frame, a date, a user name, the number of pages, a watermark, and/or the like are stored in this field 1106. As the number of items to be controlled in the printing process increases, the number of fields included in the job setting information is increased. For example, if two-sided printing is allowed, a field for specifying whether printing is to be performed in two-sided mode is embedded in the job setting information.

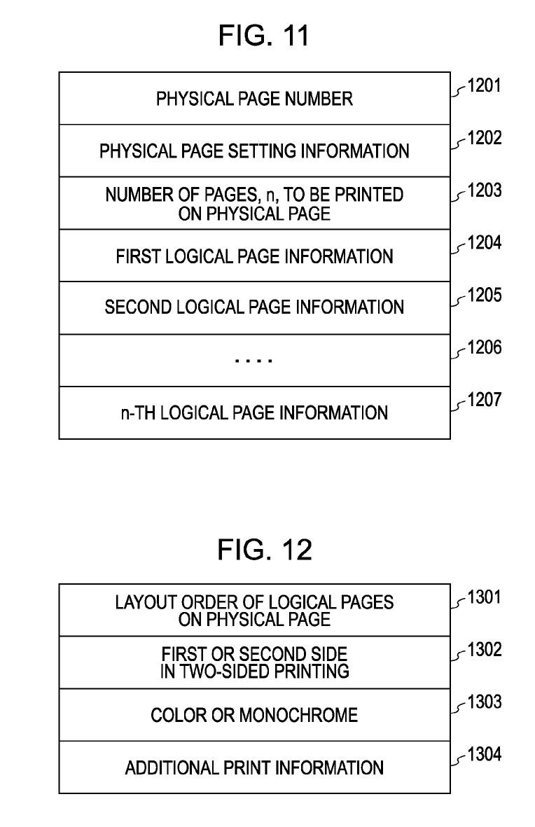

FIG. 11 shows an example of the physical page information described in the field 1004 shown in FIG. 9. In a field 1201, a physical page number is described. The value described in this field is used to manage the printing order or is used when a physical page number is additionally printed. In a field 1202, physical page setting information is described. This field is used to specify a layout or a color mode when it is allowed to specify the layout or the color mode separately for each physical page. In a field 1203, the number of logical pages to be printed on the present physical page is described. For example, when four pages are to be printed on one physical page, a numeral of “4” or an ID indicating that four logical pages are to be printed is described in this field. In a field 1204 and subsequent fields, as many pieces of logical page information as indicated in the field 1203 are stored. Depending on the number of pages output by the application 201, there is a possibility that the number of pages is smaller than the number of pages specified in the field 1203. In this case, special data indicating a blank page is embedded in the logical page information.

FIG. 12 shows an example of the physical page setting information described in the field 1202. In a field 1301, the layout order of logical pages on a physical page is specified. More specifically, this field is used to specify an order (for example, from upper left to right or from upper left to downward from upper left) of logical pages to be printed on a physical page in the N-up mode. Instead of specifying, in the field in 1301, the order of logical pages to be printed on a physical page, logical page information may be stored in fields starting from the field 1204 not in the order of pages but in the order in which pages are placed on the physical page thereby specifying the order in which to place logical pages on the physical page. In a field 1302, information indicating whether printing should be performed on the upper or lower surface of a sheet in the two-sided printing mode. For example, this information is used to form a binding margin on a correct side of the upper or lower surface. In a field 1303, information indicating whether to print the current page in a full color or monochrome mode is described. This field is used when the printer has two modes. When a document including a mixture of color and monochrome pages is printed, printing is performed in accordance with the information described in this field. That is, the operation mode of the printer is switched between the color mode and the monochrome mode in accordance with the information described in this field 1303. In a field 1304, additional print information is stored. For example, additional information such as the page number and/or a date are printed physical pages in accordance with the information described in this field 1304. Fields of the physical page setting information may be increased as required to describe further information.

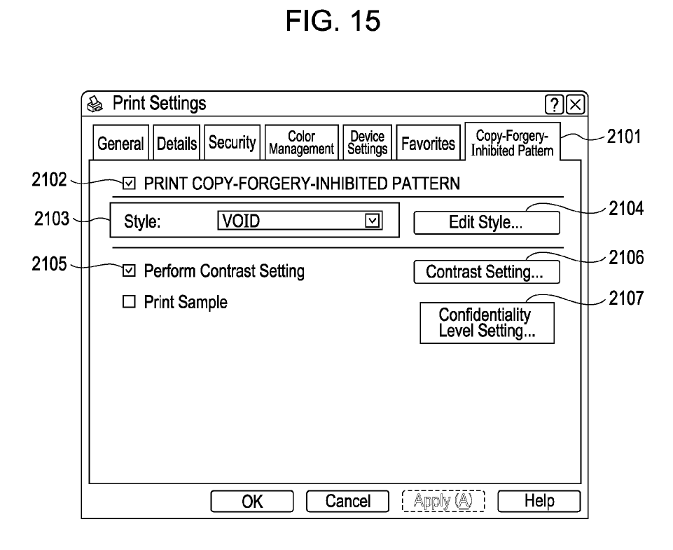

In the present embodiment, because printing of a copy-forgery-inhibited pattern image is performed so as to add the copy-forgery-inhibited pattern image to a physical page as will be described later with reference to FIG. 15 and other figures, setting information associated with printing of the copy-forgery-inhibited pattern is also described in a field 1304 in accordance with the information associated with the copy-forgery-inhibited pattern described in the field 1106 shown in FIG. 10. An example of a data format of setting information associated with additional print information 1106 for the job or associated with printing of the copy-forgery-inhibited pattern stored in the additional print information 1304 will be described later with reference to FIG. 14.

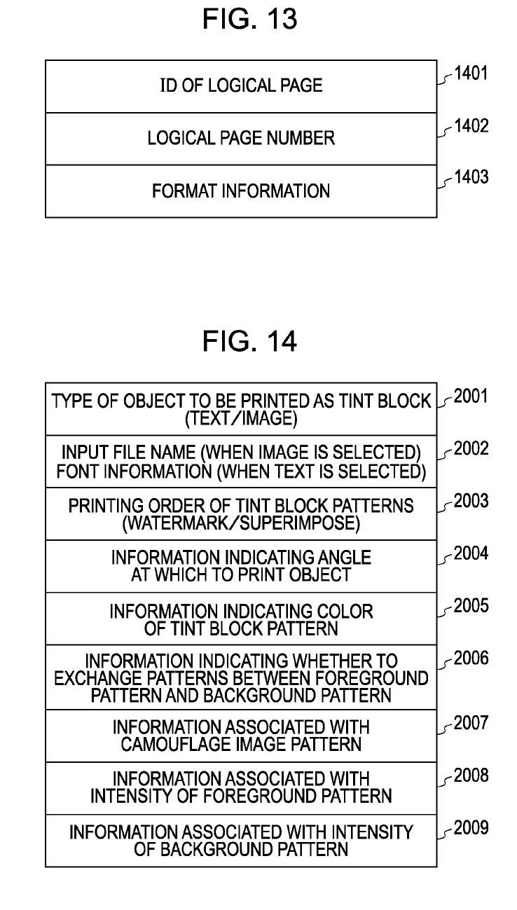

FIG. 13 shows an example of the logical page information stored in the field 1204. In a field 1401, the ID of a logical page is described. This ID is used to read intermediate codes in a page description file corresponding to a logical page from the spool file 303. A file name or a memory pointer may be used as the ID as long as it is possible to point to intermediate codes of a logical page. Alternatively, intermediate codes themselves of the logical page may be stored in this field 1401. In a field 1402, a logical page number is described. This field is used when the logical page number is printed as additional information or used as auxiliary information for the logical page ID. In a fields 1403, format information is described. The format information described in this field 1403 may include various setting items associated with the format allowed to be specified separately for respective pages. For example, additional print information such as a page frame and various kinds of setting information such as that indicating the magnification or the like specified separately for respective logical pages are stored in this field 1403. If needed, attribute information associated with the logical page, such as information specifying the color/monochrome mode may also be stored in the field 1403. When settings and/or attributes are not specified in units of logical pages, the field 1403 is not necessary.

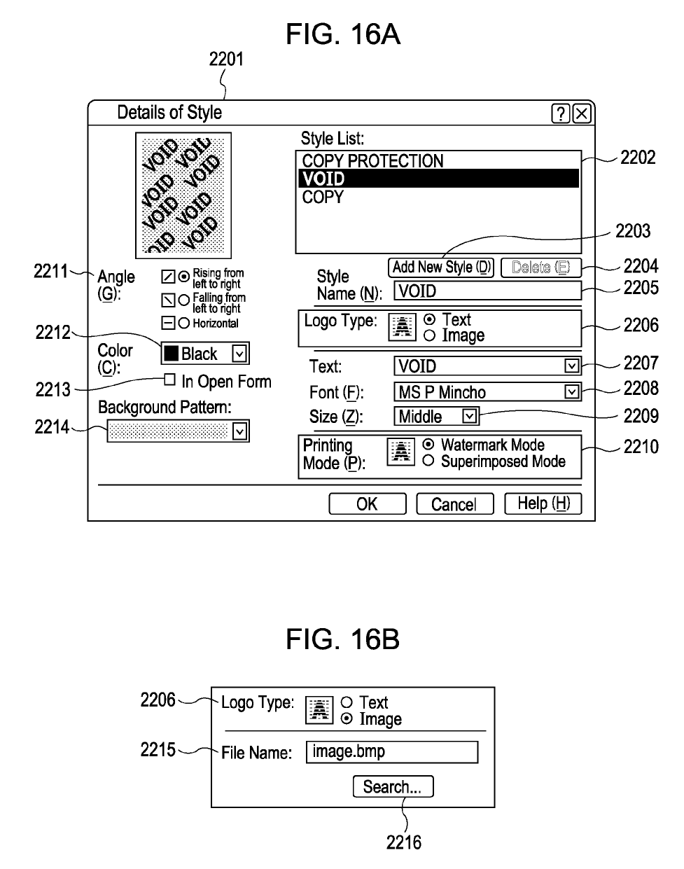

Note that in the present embodiment, information associated with the property of printing of the copy-forgery-inhibited pattern set via a setting screen such as that shown in FIG. 15 or FIG. 16A or 16B is not stored in the field 1403, so that the copy-forgery-inhibited pattern is maintained unchanged when logical pages are scaled up or down to print them in the N-up form.

The details of the job output setting file have been described above. Note that the job setting file may be described in a similar format to that of the job output setting file. That is, the job setting file includes information associated with a job in terms of a print appearance (one-sided printing, two-sided printing, or booklet printing), a print layout (N-up printing or poster printing), additional information (copy-forgery-inhibited pattern information, a watermark, a date, a user name, etc.), the number of copies to be printed, and a paper size. That is, for each physical page, information indicating the layout order of logical pages, information indicting whether to print on the upper or lower surface of a sheet in the two-sided printing, information indicating whether to print in the color mode, and other information are described.

Referring again to FIG. 3 the extended configuration also includes a setting editor 307 that allows a user to modify the settings associated with the job. In the present embodiment, data indicating the settings of the job is included in the job setting file in the case of a single job. For a combination of a plurality of jobs, data indicating the settings is included in the job output setting file shown in FIG. 9. Since such a file is produced independently of the page description file 303 in which intermediate codes are described, it is possible to modify the settings of the job by modifying the job output setting file. The modification of the job output setting file may be performed singly by the setting editor 307 or may be performed in corporation with the spool file manager 304. The modification may be performed for part or all of the job output setting file.

Printing of Copy-Forgery-Inhibited Pattern Image

FIG. 15 and FIGS. 16A and 16B show examples of user interface screens for making settings associated with printing of a copy-forgery-inhibited pattern image.

FIG. 15 shows an example of an initial screen of a user interface of the printer driver 203, for setting printing of copy-forgery-inhibited pattern image. In this example, a property sheet 2101 is displayed which allows a user to make settings associated with copy-forgery-inhibited pattern printing.

Reference numeral 2102 denotes a check box for specifying whether a print job includes printing of a copy-forgery-inhibited pattern image. Information indicating whether to print the copy-forgery-inhibited pattern image is stored in the additional print information field 1106 shown in FIG. 10. Reference numeral 2103 denotes a box for selecting an identifier (a style) from a plurality of identifiers identifying settings associated with copy-forgery-inhibited pattern printing. The printer driver 203 provides a plurality of styles one of which a user is allowed to select. The correspondence between styles and copy-forgery-inhibited pattern information shown in FIG. 14 is registered in a registry. If a button 2104 is pressed, a style edit dialog 2201 shown in FIG. 16A is displayed. A check box 2105 is used to specify whether to adjust the contrast of the foreground image and the background image in the printing of the copy-forgery-inhibited pattern. If a button 2106 is pressed, a contrast adjustment screen appears.

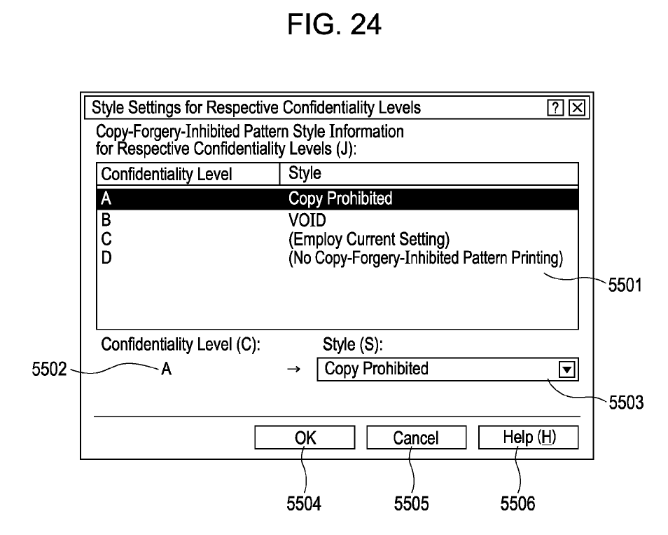

If a button 2107 is pressed, a dialog screen such as that shown in FIG. 24 appears, which allows a user to set the property or the style of the copy-forgery-inhibited pattern depending on the confidentiality level of the image such as a document to be printed, as will be described later with reference to a first embodiment of the present invention. It is allowed to select a copy-forgery-inhibited pattern style from a pull-down menu displayed in the style setting box 2103. Setting of the property of printing of the selected copy-forgery-inhibited pattern style depending on the confidentiality level of the image to be printed can be performed via the dialog screen shown in FIG. 24.

FIG. 16A shows an example of a dialog screen for specifying detailed settings associated with copy-forgery-inhibited pattern printing. This dialog screen appears when the “Edit Style” button 2104 shown in FIG. 15 is pressed.

In FIG. 16A, reference numeral 2201 denotes the style edit dialog including an area in which a preview image of a copy-forgery-inhibited pattern produced according to particular copy-forgery-inhibited pattern information (described later) is displayed. Reference numeral 2202 denotes a box in which a list of selectable styles is displayed. A button 2203 is pressed to add a new style. A button 2204 is pressed to delete a specified style. Reference numeral 2205 denotes a box in which a name of a currently selected style is displayed.

A box 2206 includes radio buttons used to select a type of an object to be used in the copy-forgery-inhibited pattern printing. For example, if a user selects “text” in the box 2206, a text object is specified. On the other hand, if a user selects “image” in the box 2206, image data such as bitmap data (BMP) is specified. In the example shown in FIG. 16A, “text” is selected and thus setting information associated with the text object are displayed in boxes 2207 to 2209 in the dialog 2201. The setting information specified in these boxes can be edited. On the other hand, in the case in which “image” is selected in the box 2206, boxes 2207 to 2209 are not displayed, but, as shown in FIG. 16B, an image file name box 2215 and a button 2216 are displayed. If the button 2216 is pressed, a file selection dialog is opened.

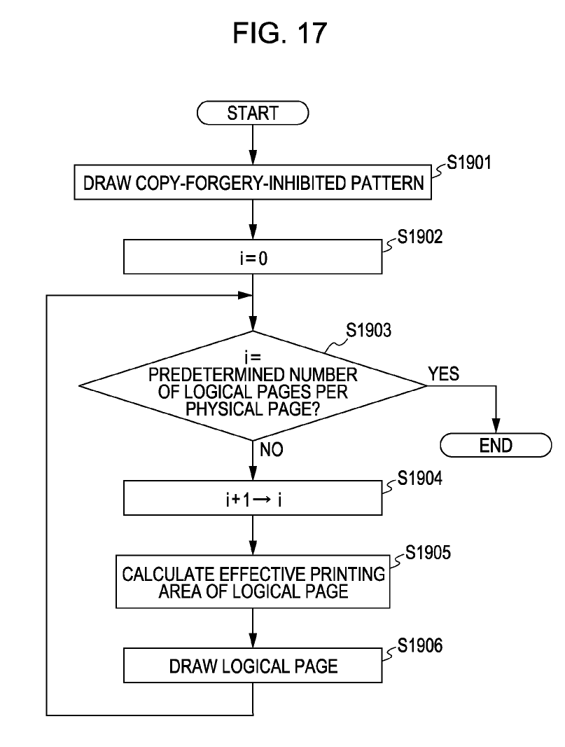

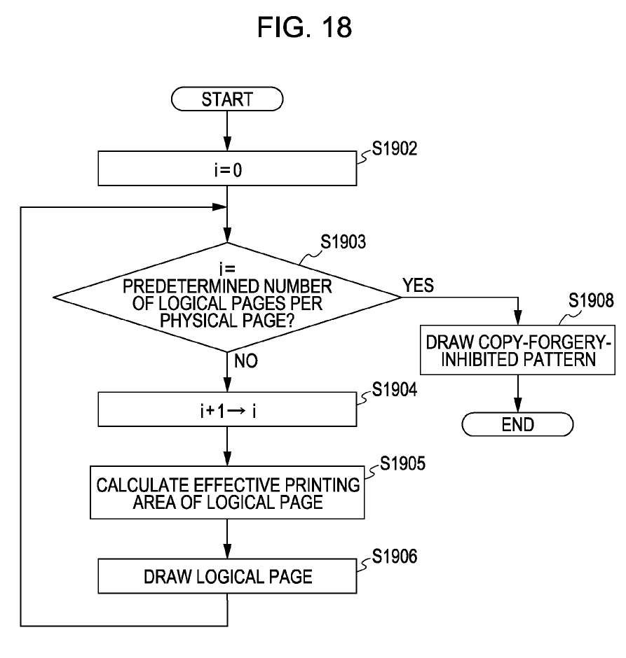

In the box 2207, a character string to be used as a copy-forgery-inhibited pattern is displayed. The character string displayed in this box 2207 is allowed to be edited. In the box 2208, a font selected for use for the character string is displayed. Although in the present embodiment, only a font name is selectable, the box 2208 may be extended so as to also allow it to select a font family (such as a bold font family, an italic font family, etc.) and/or a modified font. In the box 2209, a font for use for the character string used as the copy-forgery-inhibited pattern is selectably displayed. In the present embodiment, a font size is selectable from three sizes: a “large” size, a “middle” size, and a “small” size. Alternatively, the number of points or the like may be input to specify the font size. In a box 2210, there are provided radio buttons for selecting an order of printing a copy-forgery-inhibited pattern and document data. When a “watermark mode” is selected, the copy-forgery-inhibited pattern is first rendered and then the document data is rendered, as will be described in detail later with reference to FIG. 17. On the other hand, in the case in which a “superimposed mode” is selected, the document data is first rendered and then the copy-forgery-inhibited pattern is rendered, as will be described in detail later with reference to FIG. 18. A radio button 2211 is used to specify an angle at which to place the copy-forgery-inhibited pattern. In the present embodiment, the angle is allowed to be selected from three alternatives: rising up from left to right”, “falling down from left to right”, and “horizontal”. Alternatively, a numeric value may be input in an additional box to specify the angle, or the angle may be specified by using an additionally displayed slider bar. A box 2212 is used to specify a color of the copy-forgery-inhibited pattern (the foreground pattern or the background pattern). A check box 2213 is used to specify whether the foreground pattern and the background pattern are exchanged from each other. When this check box is not checked, printing is performed so that the foreground pattern will appear on a copied material. On the other hand, when this check box is checked, printing is performed so that the background pattern will appear on a copied material. A box 2214 is used to specify a camouflage image which allows the copy-forgery-inhibited pattern embedded in the document image to become more unperceivable. This box 2214 allows a user to select a camouflage image from a plurality of alternatives including an alternative in which no camouflage image is used.

As described above, the user is allowed to set the property of printing of the copy-forgery-inhibited pattern while referring to the preview image displayed on this dialog screen.

Data Format of Setting Information Associated with Copy-Forgery-Inhibited Pattern Printing

Referring to FIG. 14, an explanation is given below as to the data format of setting information associated with the additional information field 1106 or 1304 set via the setting screen shown in FIG. 16A or 16B.

In a field 2001 shown in FIG. 14, a value is stored which indicates the object type (text or image) drawn as the copy-forgery-inhibited pattern, specified in the box 2206 shown in FIG. 16A. In a field 2002, setting information associated with the image object specified by the information described in the field 2001 is stored. More specifically, the setting information stored in this field 2002 includes information indicating properties specified via the boxes 2207 to 2209 shown in FIG. 16A or specified via the dialog screen shown in FIG. 16B. When text is selected as the object type, information indicating a character string, a font name, and a font size is stored in this field 2002. On the other hand, when an image is selected as the object type, information indicating the location of an image file to be used is stored in the field 2002. In a field 2003, information is stored which is specified in the box 2210 shown in FIG. 16A and which indicates whether the copy-forgery-inhibited pattern is first rendered before the document data is rendered or the document data is first rendered and then the copy-forgery-inhibited pattern is rendered. In a field 2004, information is stored which is specified in the box 2211 shown in FIG. 16A and which indicates the angle at which the object should be drawn. In a field 2005, information is stored which is specified in the box 2212 shown in FIG. 16A and which indicates the color of the copy-forgery-inhibited pattern (the foreground pattern or the background pattern). In a field 2006, information is stored which is specified in the check box 2213 shown in FIG. 16A and which indicates how to deal with the foreground pattern and the background pattern. In a field 2007, information is stored which is specified in the box 2214 shown in FIG. 16A and which indicates a pattern specified as the camouflage image. In a field 2008, intensity information of the foreground pattern specified via the contrast adjustment screen is stored. In a field 2009, intensity information of the background pattern specified via the contrast adjustment screen is stored.

Rendering of Copy-Forgery-Inhibited Pattern

FIGS. 17 and 18 show rendering processes performed in the copy-forgery-inhibited pattern printing according to an embodiment of the present invention. When the watermark mode is specified via the setting screen shown in FIG. 16A, rendering is performed according to the flow chart shown in FIG. 17. On the other hand, when the superimposed mode is specified, rendering is performed according to the flow chart shown in FIG. 18. Note that the rendering process described herein is performed in the printing process in step S708 shown in FIG. 6.

First, referring to the flow chart shown in FIG. 17, the rendering process in the watermark mode is described. In this mode, the copy-forgery-inhibited pattern is first rendered before the document data is rendered. In the watermark mode, as described above, copy-forgery-inhibited pattern image data is first rasterized in the bitmap memory of the printer, and subsequently the document data is rasterized on the copy-forgery-inhibited pattern image data. Thus, in the watermark mode, print data of the copy-forgery-inhibited pattern image is first produced, and then document print data is produced.

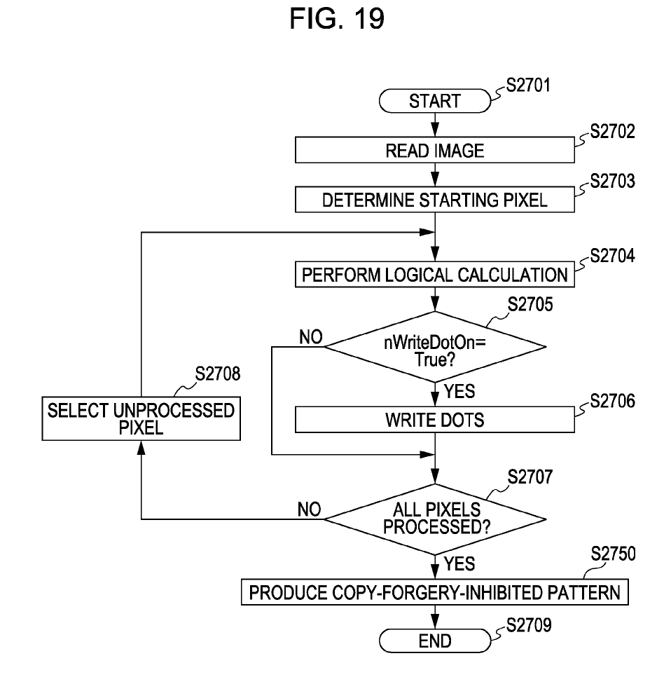

In step S1901, rendering is performed in accordance with copy-forgery-inhibited pattern information shown in FIG. 14. The details of this rendering process will be described later with reference to FIG. 19. After completion of rendering of the copy-forgery-inhibited pattern, rendering of the document data is performed. In step S1902, the counter is initialized. In step S1903, a determination is made as to whether the counter value is equal to a predetermined maximum allowable number of pages per physical page. If the determination is that the counter value is equal to the predetermined maximum allowable number of pages per physical page, then the process proceeds to step S1908, or otherwise the process proceeds to step S1904. In step S1904, the counter is incremented by 1. In step S1905, in accordance with the number of pages per physical page and the counter value, the effective printing area in which to draw the current logical page is calculated. In step S1906, the current logical page number is read, using the counter value as an index, from the information associated with the physical page whose property is set via the setting screen shown in FIG. 8, and the current logical page is rendered into a scaled-down form so as to be placed within the effective printing area. Note that when the N-up printing mode is not specified, scaling down is not necessary.

Now, referring to a flow chart shown in FIG. 18, a rendering process in a superimposed mode is described, in which document data is first rendered and then a copy-forgery-inhibited pattern is rendered. On the other hand, in the “superimposed mode”, as described above, the document data is first rasterized in the bitmap memory of the printer, and then the copy-forgery-inhibited pattern image is rasterized on the document data. Thus, in the superimposed mode, the document print data is first produced, and then print data of the copy-forgery-inhibited pattern image is produced.

In step 1902, the counter is initialized. In step S1903, it is determined whether the counter value is equal to a predetermined maximum allowable number of pages per physical page. If the determination is that the counter value is equal to the predetermined maximum allowable number of pages per physical page, then the process proceeds to step S1908, or otherwise the process proceeds to step S1904. In step S1904, the counter is incremented by 1. In step S1905, in accordance with the number of logical pages per physical page and the counter value, the effective printing area in which to draw the current logical page is calculated. In step S1906, the current logical page number is detected from the information associated with the physical page given in the form shown in FIG. 8, by using the counter value as an index, and the current logical page is rendered into a scaled-down form so as to be placed within the effective printing area. Note that when the N-up printing mode is not specified, scaling down is not necessary. If rendering of the predetermined number of logical pages for the physical page is completed, the process proceeds to step S1908. In step S1908, a copy-forgery-inhibited pattern is drawn in the effective printing area of the physical page specified by the application in accordance with the copy-forgery-inhibited pattern information shown in FIG. 14. This process will be described in further detail later with reference to FIG. 19.

FIG. 19 is a flow chart showing the details of the process of rendering the copy-forgery-inhibited pattern in step S1901 in FIG. 17 or in step S1908 in FIG. 18. Referring to the flow chart shown in FIG. 19, the process of rendering the copy-forgery-inhibited pattern is described below.

In step S2701, if a start command is issued via the user interface, the copy-forgery-inhibited pattern drawing process is started. Next, in step S2702, an input background image, a background threshold pattern, a foreground threshold pattern, a foreground/background area defining image, and a camouflage area defining image, are read. In step S2703, a starting pixel at which to start drawing of the copy-forgery-inhibited pattern image is determined. For example, in a case in which the tilt block image is formed by means of raster scanning starting from the upper left corner to the lower right corner, a pixel in the upper left corner is selected as the starting pixel.

Next, in step S2704, the copy-forgery-inhibited pattern processing unit 205 places background threshold patterns, foreground threshold patterns, base images, and camouflage images, in the form of an array of tiles starting from the upper left corner of the copy-forgery-inhibited pattern image area in accordance with formula (1) shown below.
nWriteDotOn=nCamouflage×(nSmallDotOn× [symbol] nHiddenMark+nLargeDotOn×nHiddenMark) (1)
On the basis of the result of the calculation according to equation (1), a determination is made as to whether to write pixel values corresponding to dots of a printed material into a memory area. Note that the pixel values represent colors at respective pixels. Also Note that the background threshold pattern and the foreground threshold pattern are pattern data consisting of “1”s indicating that writing of corresponding dots should be performed and “0”s indicating that writing of corresponding dots should not be performed. These pattern data are represented in a binarized form using dither matrices indicating the dot positions of the foreground image (latent image) and the background image.

Terms in equation (1) are explained below. nComouflage takes a value of 0 when in the camouflage image, a pixel of interest is a pixel of the camouflage pattern, or otherwise takes a value of 1. nSmallDotOn takes a value of 1 when a pixel of interest of the background threshold pattern is black but takes a value of 0 when the pixel of interest is white (note that the color is not limited to white). nLargeDotOn takes a value of 1 when a pixel of interest of the foreground threshold pattern is black but takes a value of 0 when the pixel of interest is white (note that the color is not limited to white).

nHiddenMark takes a value of 1 when in the base image, a pixel of interest is a pixel of the latent mark image, but takes a value of 0 when the pixel of interest is a pixel of the background image.

[symbol] HiddenMark is an inversion of nHiddenMark, that is, nHiddenMark takes a value of 0 in the foreground area and a value of 1 in the background area.

Note that the calculation for a pixel of interest does not necessarily need to be performed for all terms in equation (1), but unnecessary calculation may be omitted. This allows an increase in the processing speed.

For example, if nHiddenMark=1, then [symbol] nHiddenMark=0. If nHiddenMark=0, then [symbol] nHiddenmark=1. Therefore, if nHiddenMark=1, then the value given by formula (2) described below can be employed as the value of nLargeDotOn. On the other hand, if nHiddenMark=0, then the value given by formula (2) can be employed as the value of nSmallDotOn. Note that because formula (1) is in the form of the product of nComouflage and the other term, if nComouflage=0 then nWriteDotOn=0, and thus the calculation of formula (2) may be omitted when nComouflage=0.
(nSmallDotOn× [symbol] nHiddenMark+nLargeDotOn×nHiddenMark) (2)

In the production of the copy-forgery-inhibited pattern image, the unit pattern size which is drawn periodically is given by the least common multiple of the sizes of the background threshold pattern, the foreground threshold pattern, the base pattern, and the camouflage image in each of vertical and horizontal directions. Therefore, the copy-forgery-inhibited pattern processing unit 205 may produce only the unit pattern and may produce the total copy-forgery-inhibited pattern image by placing the unit pattern periodically in the form of an array of tiles. This allows a reduction in the processing time spent to produce the copy-forgery-inhibited pattern image.

In step S2705, the CPU 1 checks the result of the calculation of the value of nWriteDotOn performed in step S2704. If nWriteDotOn=1, the process proceeds to step S2706. However, if nWriteDotOn=0, the process proceeds to step S2707.

In step S2706, the pixel values of dots to be printed are written. The pixel values may be varied depending on the color of the copy-forgery-inhibited pattern image. For example, when a black copy-forgery-inhibited pattern is to be formed, the pixel values of corresponding dots of the copy-forgery-inhibited pattern image are set to a value corresponding to the black level. In a case in which a copy-forgery-inhibited pattern is to be formed in another specified color, the pixel values are set to a value corresponding to cyan, magenta, or yellow so as to obtain the specified color taking into account the toner or ink colors available on the printer used. In a case in which each pixel of image data is expressed using one to several bits, the pixel value may be expressed using index color. In the method of representing image data using index color, colors which appear frequently in the color image are expressed by indexes. For example, white is expressed by index 0, cyan is expressed by index 1, and so on. According to the above definition of the color indexes, the pixel values of the respective pixels are expressed by index numbers. For example, the pixel value of a first pixel is expressed by index 1, the pixel value of a second pixel is expressed by index 2, and so on.

In step S2707, a determination is made as to whether the process is completed for all pixels in the area of interest. If the process is not completed for all pixels in the area of interest, the process proceeds to step S2708. In step S2708, an unprocessed pixel is selected, and the selected pixel is processed by again performing steps 2704 to S2706.

In step S2750, a copy-forgery-inhibited pattern is produced on the basis of the pixel values determined in steps S2704 to S2708.

Thus, the copy-forgery-inhibited pattern image is produced by performing the above-described process on the input background image. In the copy-forgery-inhibited pattern image obtained via the above-described process, there is a possibility that the dot density becomes high near the boundary between the foreground and the background in the foreground/background area defining image, and thus the outline of the foreground becomes perceivable, which can reduce the effectiveness of the copy-forgery-inhibited pattern. To avoid the above problem, boundary processing may be performed to prevent the dot density from becoming high near the boundary between the foreground and the background in the foreground/background area defining image.

In the printing system configured in the above-described manner so as to be capable of printing copy-forgery-inhibited pattern image, the property of printing of the copy-forgery-inhibited pattern image may be automatically set. Some specific examples of processes of automatically setting the property of printing of the copy-forgery-inhibited pattern image are described below. In these examples, the setting is performed by the printer driver.

### First Exemplary Embodiment

Setting of Copy-Forgery-Inhibited Pattern According to Confidentiality Level of Image to be Printed

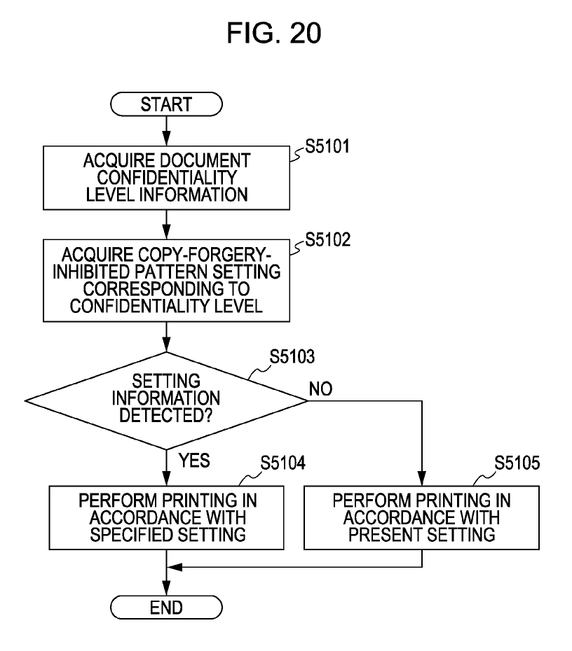

FIG. 20 is a flow chart showing a process of making settings of a copy-forgery-inhibited pattern depending on the confidentiality level of an image such as a document image to be printed, according to an embodiment of the present invention. This process is performed by the CPU 1 of the host computer 3000 shown in FIG. 1 by reading program code stored in the external memory 11 and executing it.

Note that this process is performed when the copy-forgery-inhibited pattern processing unit 205 (FIG. 2 or 3) stores information associated with printing of the copy-pattern in the additional print information field 1106 shown in FIG. 10.

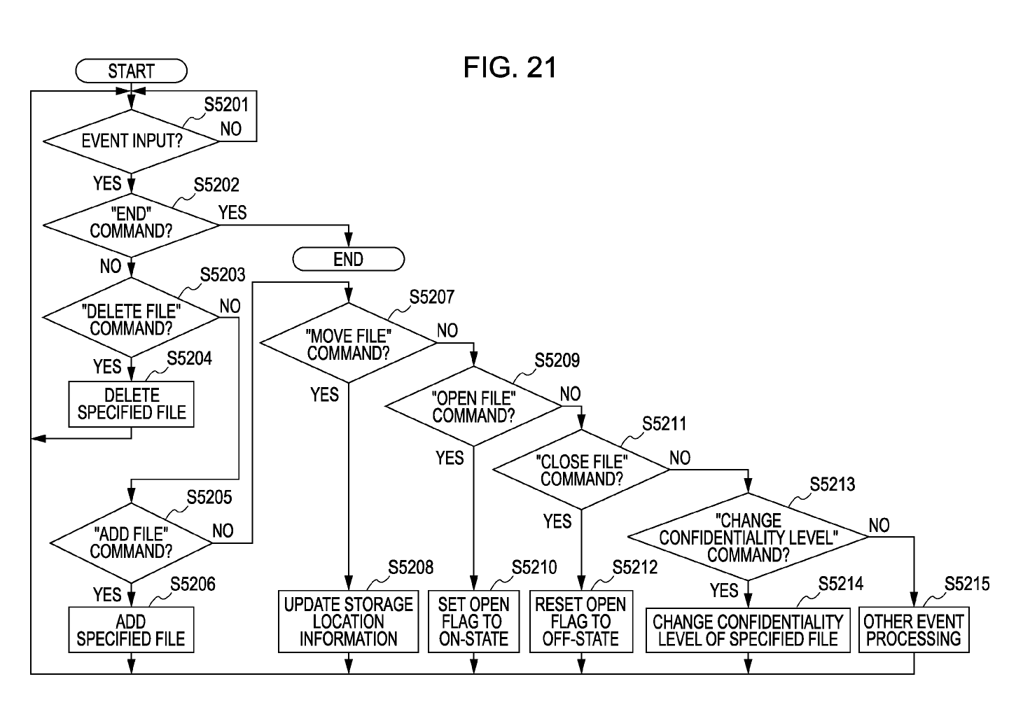

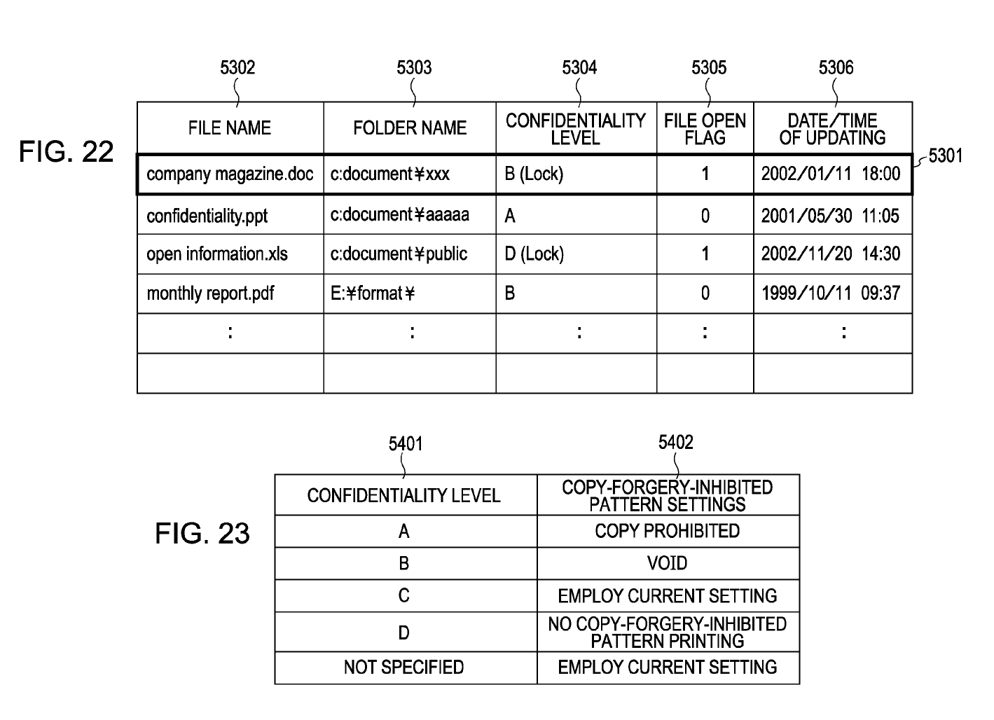

First, in step S5101, information indicating the confidentiality level specified for a document to be printed is acquired. More specifically, if a user specifies a document using a pointing device such as a mouse, the host computer 3000 identifies the document specified by the user. On the basis of the identifier (file name) of the specified document, file information which will be described later with reference to FIG. 22 is examined to acquire information indicating the confidentiality level assigned to the document. More specifically, in the present example, the confidentiality level assigned to the image to be printed is detected, and the property of the copy-forgery-inhibited pattern image (style) is automatically set by the printer driver, depending on the confidentiality level. In the present example, as described above, the printer driver automatically sets the property of printing of the copy-forgery-inhibited pattern image in accordance with the confidentiality level assigned to the image to be printed. The manner of acquiring the confidentiality level of the document to be printed is described later with reference to FIGS. 21 and 22. Although in the present example, it is assumed that the image to be printed is a document, the image to be printed is not limited to documents, but other types of images may be used as long as confidentiality levels are defined for the images.

In step S5102, information specifying a copy-forgery-inhibited pattern corresponding to the confidentiality level determined in step S5101 is acquired. In the present embodiment, setting of the property of the copy-forgery-inhibited pattern is performed by specifying style information (which indicates the type of copy-forgery-inhibited pattern image), which will be described in further detail later. Thus, setting of the property of the copy-forgery-inhibited pattern depending on the confidentiality level is performed by specifying style information. As described above with reference to FIG. 15, the style information may include a plurality of items associated with the copy-forgery-inhibited pattern. For example, as described above with reference to FIG. 16, the style information may include not only information specifying a character string, but information specifying other properties thereof such as an angle, a color, a background pattern, a logo type, a size, etc. The copy-forgery-inhibited pattern specified by the style information may be different, even if only one of the plurality of items (for example, a color) is changed. The correspondence between confidentiality levels and styles of the copy-forgery-inhibited pattern and the manner in which to define the correspondence between them will be described later with reference to FIGS. 23 and 24.

In step S5103, it is determined whether the style of the copy-forgery-inhibited pattern corresponding to the confidentiality level determined in step S5101 is included in a set of predefined styles of copy-forgery-inhibited patterns such as those shown in FIG. 23 or 24.

If the specified copy-forgery-inhibited pattern style is found in the set of predefined styles, the processing flow proceeds to step S5104. In step S5104, the copy-forgery-inhibited pattern style is described in the field 1106 shown in FIG. 10, and printing is performed in accordance with the specified copy-forgery-inhibited pattern style. On the other hand, if the specified copy-forgery-inhibited pattern style is not found in step S5103, the processing flow proceeds to step S5105, in which printing is performed using an existing (default) copy-forgery-inhibited pattern style.

Acquisition of Information Indicating the Confidentiality Level Assigned to Copy-Forgery-Inhibited Pattern Image

FIG. 21 is a flow chart showing a document management process associated with a process, in step S5101 in FIG. 20, of acquiring confidentiality level information of a document, according to an embodiment of the present invention. This process is performed by the CPU 1 of the host computer 3000 shown in FIG. 1 in accordance with program code stored in the external memory 11.

In the process shown in FIG. 21, it is assumed by way of example that a document management module is activated to define a confidentiality level to a document file, and the document management module monitors the status of documents. Alternatively, a module adapted to manage the document property information may be activated in response to a request issued by the printer driver, and the module may return the confidentiality level to the printer driver.

First, in step S5201, the document management module waits for an occurrence of an event. If an event occurs, the processing flow proceeds to step S5202. In step S5202, it is determined whether the event is an end command. If so, the process is ended. However, is the answer to step S5202 is No, the processing flow proceeds to step S5203 to determine whether the event is deleting of a file being monitored. If the answer to step S5203 is Yes, a record associated with the file is deleted from file information stored in the document management module. The processing flow then returns to step S5201 to wait for a next event. In the example shown in FIG. 22, file information associated with each file is described in a record such as that denoted by a reference numeral 5301. Thus, information associated with the file is deleted by deleting the corresponding record.

FIG. 22 shows an example of a data format of information indicating the confidentiality levels defined for respective documents, according to an embodiment of the present invention. The file information shown in FIG. 22 may be stored in an external computer connected to the host computer 3000 via a network so that the host computer 3000 can access the file information. Each record of the file information includes a file name field 5302, and a folder name field 5303 indicating a name of folder in which a file is stored. In the example shown in FIG. 22, a path indicating the storage location of a file is described in the folder name field 5303. Each record further includes a field 5304 for describing the confidentiality level for the corresponding file, a file open flag 5305 indicating whether the file is in an open or closed state, and a field 5306 for describing the date/time of updating the file information. If necessary, the record may be extended so as to be capable of describing further items of each file. The information shown in FIG. 22 may be stored in the form of a file or may be stored in a memory space.

Referring again to FIG. 21, in a case in which it is determined in step S5203 that the event is not deleting of a file, the processing flow proceeds to step S5205 to determine whether the event is addition of a file to be monitored. If the answer to step S5205 is Yes, then the process proceeds to step S5206. In step S5206, information associated with the added file is described in a record of the file information shown in FIG. 22. Thereafter, the process returns to step S5201 to wait for a next event. On the other hand, if the event is not addition of a file, then the process proceeds to step S5207. In step S5207, it is determined whether the event is movement of a file being monitored. If the answer to step S5207 is Yes, the process proceeds to step S5208. In step S5208, the storage position 5303 of the file is updated (recorded). Thereafter, the process returns to step S5201 to wait for a next event. Note that the information indicating the confidentiality level assigned to the moved file is maintained unchanged. In this process in step S5208, because the information indicating the confidentiality level assigned to the file is maintained unchanged, the management of documents in terms of applying copy-forgery-inhibited pattern images is performed in a highly reliable fashion. For example, when certain document data is moved from a certain folder to another folder, the property of printing of a copy-forgery-inhibited pattern image defined for this document data is maintained, and thus it is possible to apply the copy-forgery-inhibited pattern image in a highly reliable fashion. On the other hand, if it is determined in step S5207 that the event is not movement of a file, then the process proceeds to step S5209. In step S5209, it is determined whether the event is opening of a file being monitored. If the answer to step S5209 is Yes, the process proceeds to step S5210. In step S5210, the file open flag 5305 associated with this file is set into an on-state. Thereafter, the process returns to step S5201 to wait for a next event. On the other hand, if it is determined in step S5209 that the event is not opening of a file, then the process proceeds to step S5211, in which it is determined whether the event is closing of a file being monitored. If the answer to step S5211 is Yes, the process proceeds to step S5212. In step S5212, the file open flag 5305 associated with this file is reset into an off-state. Thereafter, the process returns to step S5201 to wait for a next event. In a case in which it is determined in step S5211 that the event is not closing of a file, then the process proceeds to step S5213, in which it is determined whether the event is changing of the confidentiality level of a file being monitored.

If it is determined in step S5213 that the event is changing of the confidentiality level, then the process proceeds to step S5214. In step S5214, the confidentiality level information described in the field 5304 for the file is updated. Thereafter, the process returns to step S5201 to wait for a next event. On the other hand, if it is determined in step S5213 that the event is not changing of the confidentiality level, the processing flow proceeds to step S5215. In step S5215, another event handling process is performed. Thereafter, the process returns to step S5201 to wait for a next event.

When printing is performed, the copy-forgery-inhibited pattern processing unit 205 acquires a file name (a document identifier or a document ID) from an application program via the graphic engine 202, and searches the file information shown in FIG. 22 for a record having the same file name in the field 5302 as the acquired file name. If such a record is found, the confidentiality level for the document is detected from the record.

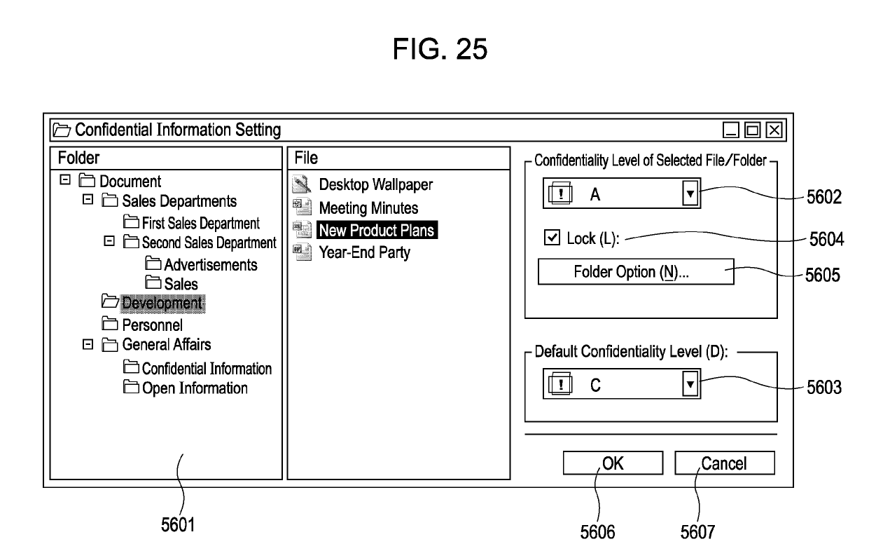

FIG. 25 shows an example of a setting screen provided by the document management module or by the OS (Operating System) to allow a user to set the confidentiality level for each document, according to an embodiment of the present invention. On this setting screen shown in FIG. 25, it is allowed to easily define the same confidentiality level for a plurality of document data or different confidentiality levels for respective document data. The file information shown in FIG. 22 described above is produced on the basis of the setting made via the setting screen shown in FIG. 25.

In an area 5601 of the setting screen shown in FIG. 25, files and folders are displayed in a tree view form or the like. A box 5602 is used to define the confidentiality level for one or more files and/or one or more folders selected in the area 5601.

A drop-down list box 5603 is used to define a default confidentiality level to be assigned to general files or folders. In general, it is troublesome to define the confidentiality level separately for all files. In this regard, the capability of defining the default confidentiality level via the box 5603 is useful. A check box 5604 is used to lock the defined confidentiality level. For files whose confidentiality level is locked via this check box 5604, information indicating that the confidentiality level is locked is described in the confidentiality level field 5304 shown in FIG. 22. A button 5605 is used to make detailed settings for files in a folder selected in the area 5601. If this button 5605 is pressed, a dialog screen (not shown) appears which allows it to make detailed settings for respective files. In the setting, for example, the same confidentiality level may be assigned to a plurality of files having the same file extension. It is possible to realize settings of further details by extending the manner of managing the documents, although a further explanation thereof is omitted herein.

In FIG. 25, if an OK button 5606 is clicked, the setting made in this dialog screen becomes effective. If a Cancel button 5607 is clicked, the setting made in this dialog screen is canceled and the dialog screen is closed.

Correspondence Between Confidentiality Levels and Styles of Copy-Forgery-Inhibited Pattern and a Method of Defining the Correspondence

Details of the process, in step S5102 in FIG. 20, of defining the correspondence between confidentiality levels and styles of copy-forgery-inhibited pattern and a method of storing the data thereof are described below with reference to FIGS. 23 and 24.

FIG. 23 shows an example of a data format of information indicating the correspondence between the confidentiality levels and copy-forgery-inhibited pattern properties, according to an embodiment of the present invention. The information described herein is referred to and updated by the copy-forgery-inhibited pattern processing unit 205. That is, this information indicating the confidentiality levels and the copy-forgery-inhibited pattern properties is referred to in step S5102 in FIG. 20, and the information is updated in accordance with a setting operation performed by a user via the setting screen shown in FIG. 24.

In FIG. 23, in fields in a column 5401, confidentiality levels are described which are selectable as a confidentiality level in the confidentiality level field 5304 in FIG. 22. In fields in a column 5402, copy-forgery-inhibited pattern properties defined for respective confidentiality levels are described. More specifically, identification information identifying copy-forgery-inhibited pattern styles displayed in the form of a list in the style information box 2103 shown in FIG. 15 is stored in the column 5402. In the box 2103, as described above, a list of identifiers (styles) identifying respective settings of copy-forgery-inhibited pattern printing is provided to allow a user to set a style in the printer driver 203.

In the example shown in FIG. 23, four confidentiality levels A to D are defined. In the fields in the column 5402, in addition to the copy-forgery-inhibited pattern properties defined in the style information box 2103 shown in FIG. 15, “current property” and “no copy-forgery-inhibited pattern printing” are defined. For documents having the lowest confidentiality level D, “no copy-forgery-inhibited pattern printing” is defined. The presence of “current property” as one of choices provides high usability to the setting user interface described later with reference to FIG. 24. In the present embodiment, it is assumed that these pieces of information are stored in the registry, although it is allowed to store the information in other forms such as a file.

FIG. 24 shows an example of a user interface which appears, when the button 2107 in FIG. 15 is pressed, to allow a user to define the correspondence between confidentiality levels and copy-forgery-inhibited pattern properties (styles), according to an embodiment of the present invention. That is, via this user interface, it is allowed to set or modify the correspondence between the confidentiality levels and copy-forgery-inhibited pattern properties (styles) shown in FIG. 23.

In FIG. 24, a list of copy-forgery-inhibited pattern properties, that is, copy-forgery-inhibited pattern styles defined for respective confidentiality levels is displayed in a list box 5501 such that the correspondence between one confidentiality level and one copy-forgery-inhibited pattern style is displayed in one row. In this list box 5501, if a row indicating the correspondence between a particular confidentiality level and a particular copy-forgery-inhibited pattern style is selected, the selected row is highlighted, and the selected confidentiality level is displayed in an area 5502 and the corresponding copy-forgery-inhibited pattern style is displayed in a drop-down list box 5503. In this state, if the drop-down list box 5503 is clicked, a list of selectable styles is displayed. In addition to the styles displayable on the setting screen shown in FIG. 15, the list displayed in the drop-down list box 5503 also includes “no copy-forgery-inhibited pattern printing” and “current style”.

The “current style” allows it to employ the current style which is allowed to be dynamically defined or modified via the setting screen shown FIG. 15 or 16A. In the specific example shown in FIG. 15, “VOID” is selected as the current style. Employment of the “current style” may be allowed regardless of whether the check box “Print copy-forgery-inhibited pattern” 2102 shown in FIG. 15 is checked or not, or may be allowed only when this check box 2102 is checked. It is reasonable to select “no copy-forgery-inhibited pattern printing” for documents which are low in confidentiality level and thus do not need a copy-forgery-inhibited pattern. This setting can cause a document to be printed without any copy-forgery-inhibited pattern even when a user sets a job so as to be printed with a copy-forgery-inhibited pattern.

To define a new correspondence or change an existing correspondence between a confidentiality level and a style shown in the box 5501, a style to be assigned to a confidentiality level shown in the area 5502 is selected in the box 5503.

In FIG. 24, if an OK button 5504 is clicked, the setting made in this dialog screen becomes effective. If a Cancel button 5505 is clicked, the setting made in this dialog screen is canceled and the dialog screen is closed. If a Help button 5506 is clicked, help information associated with this dialog screen is displayed.

In the present embodiment, as described above, the printer driver automatically sets the property of printing of a copy-forgery-inhibited pattern image in accordance with the confidentiality level defined for an image to which to apply the copy-forgery-inhibited pattern image. This makes it possible to properly set the property of a copy-forgery-inhibited pattern image each time an image such as a document is printed, without needing an operation by a user, that is, without depending on an arbitrary decision by the user. Furthermore, it becomes possible for a user to make detailed settings associated with the property of the copy-forgery-inhibited pattern for each document.

### Second Exemplary Embodiment

In a second embodiment of the present invention, as in the first embodiment described above, the printer driver automatically sets the property of printing of a copy-forgery-inhibited pattern image. However, in this second embodiment, unlike the first embodiment, the setting is made in accordance with user information.

Setting of Property of Copy-Forgery-Inhibited Pattern According to User Information

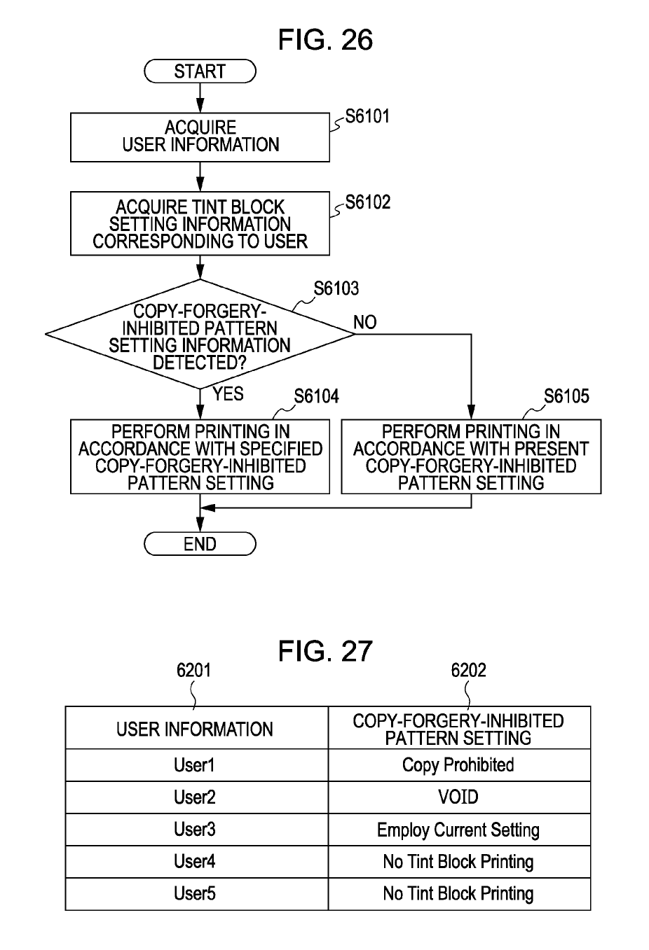

FIG. 26 is a flow chart showing a process of setting the property of printing of a copy-forgery-inhibited pattern image depending on user information in accordance with the second embodiment of the invention. Note that this process is performed when the copy-forgery-inhibited pattern processing unit 205 stores copy-forgery-inhibited pattern information in the field 1106 shown in FIG. 10.

First, in step S6101, the printer driver 203 acquires, from the OS, user information associated with a document to be printed. In general, the OS has job information (in the case of the Windows (trademark), job information is stored as JOB_INFO structure) including information indicating a user name of a user who has issued a job. The user name is then identified from the acquired user information.

In step S6102, information indicating copy-forgery-inhibited pattern styles assigned to respective users identified by the user information. A method of assigning copy-forgery-inhibited pattern styles to users and a data format of assignment information will be described later with reference to FIGS. 27 to 30.

In step S6103, it is determined whether the information indicating the assignment of copy-forgery-inhibited pattern styles acquired in step S6102 includes a copy-forgery-inhibited pattern style assigned to the present user of interest. If an assigned copy-forgery-inhibited pattern style is found, the process proceeds to step S6104. In step S6104, the found copy-forgery-inhibited pattern style is stored in the field 1106 shown in FIG. 10, and printing is performed in accordance with the assigned copy-forgery-inhibited pattern style. In a case in which no copy-forgery-inhibited pattern style is found in step S6103, the process proceeds to step S6105. In step S6105, printing is performed in accordance with an existing (current) copy-forgery-inhibited pattern style.

Correspondence Between User Information and Styles and a Method of Defining of the Correspondence

Referring to FIG. 27, the details of the process in step S6102 in FIG. 26 of acquiring the correspondence between user information and copy-forgery-inhibited pattern styles are described. FIG. 27 shows an example of a data format of information indicating the correspondence between user information and copy-forgery-inhibited pattern styles (properties) according to an embodiment of the present invention. The information described herein is referred to and updated by the copy-forgery-inhibited pattern processing unit 205. By referring to this information, it is possible in step S6102 in FIG. 26 to acquire the correspondence between copy-forgery-inhibited pattern styles and user information. By setting the data shown in FIG. 27, it is possible to define in advance the correspondence between user information and copy-forgery-inhibited pattern styles.

In FIG. 27, in fields in a column 6201, user information is described. In fields in a column 6202, corresponding copy-forgery-inhibited pattern styles (properties) are described. More specifically, in fields in the column 6202, identification information identifying copy-forgery-inhibited pattern styles displayed in the form of a list in a box similar to the box 2103 in FIG. 15 according to the first embodiment is stored. As described above, the box 2103 is for selecting a copy-forgery-inhibited pattern style from a plurality of alternatives by specifying an identifier (style). This allows a user to set a style in the printer driver 203.

In the present embodiment, copy-forgery-inhibited pattern styles definable in the fields in the column 6202 includes not only those defined via the box 2103 but may also include current property” and “no copy-forgery-inhibited pattern printing”. In the present embodiment, it is assumed that these pieces of information are stored in the registry, although it is allowed to store the information in other forms such as a file.

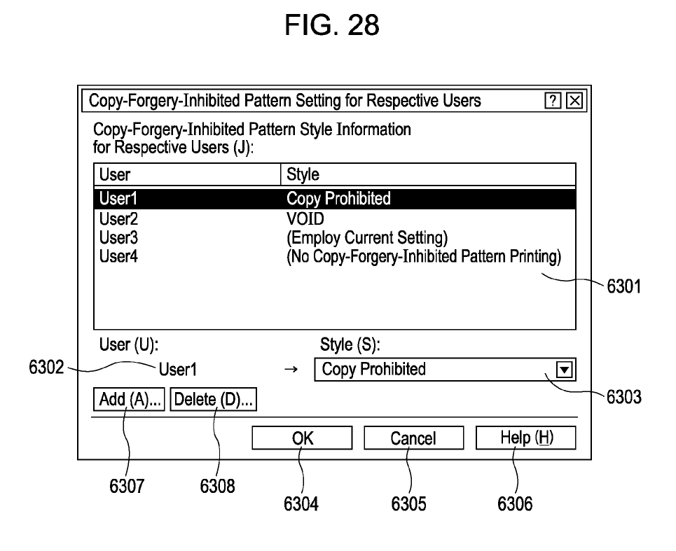

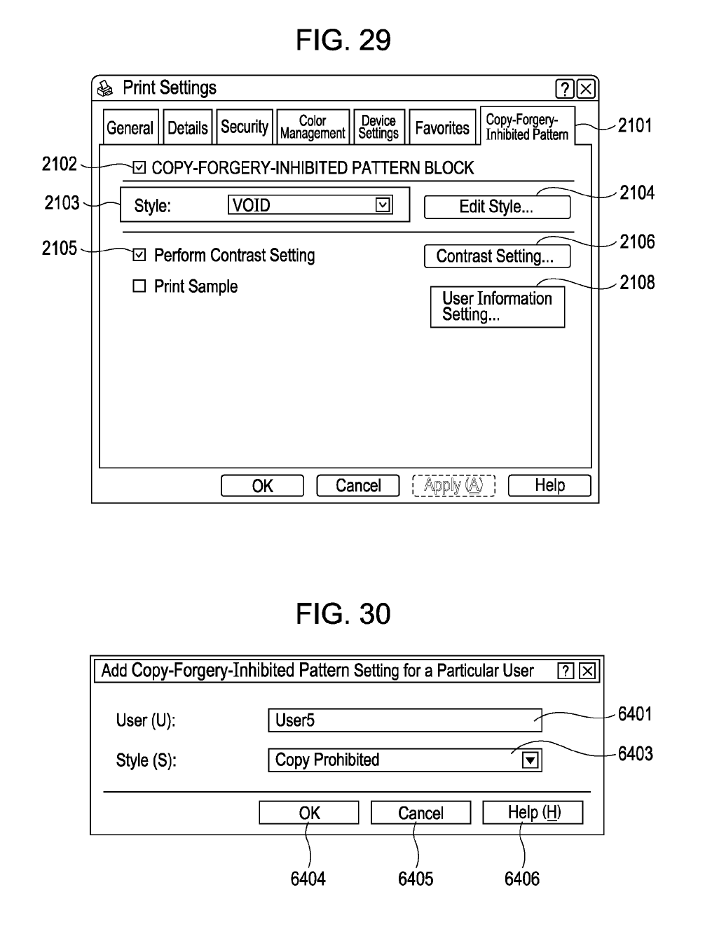

FIG. 28 shows an example of a user interface which appears, when the “User Information Setting” button 2108 in FIG. 29 is clicked, to allow a user to define the correspondence between user information and copy-forgery-inhibited pattern styles (properties). In accordance with information input via the user interface shown in FIG. 28, the data shown in FIG. 27 is produced.

In FIG. 28, a list of copy-forgery-inhibited pattern properties, that is, copy-forgery-inhibited pattern styles assigned to respective users identified by user information is displayed in a list box 6301 such that the correspondence between one user and one copy-forgery-inhibited pattern style is displayed in one row. In this list box 6301, if a row indicating the correspondence between a particular user and a particular copy-forgery-inhibited pattern style is selected, the selected row is highlighted, and user information identifying the selected user is displayed in an area 6302 and the corresponding copy-forgery-inhibited pattern style is displayed in a drop-down list box 6303. In this state, if the drop-down list box 6303 is clicked, a list of selectable copy-forgery-inhibited pattern styles is displayed. In addition to those displayable in the box 2103 shown in FIG. 29, the list shown in the box 6303 also includes “no copy-forgery-inhibited pattern printing” and “current style”. The “current style” allows it to dynamically employ the current style defined or modified via the setting screen shown FIG. 29 or 16. It is reasonable to select “no copy-forgery-inhibited pattern printing” for users who do not need copy-forgery-inhibited pattern images.

In FIG. 28, if an Add button 6307 is clicked, a dialog screen shown in FIG. 30 appears, which allows a user to define a new copy-forgery-inhibited pattern style for a user identified by user information. The information indicating the new definition is embedded in the data shown in FIG. 27. If a Delete button 6308 is clicked, a record of definition of a copy-forgery-inhibited pattern style for user information selected in the box 6301 is deleted from the data shown in FIG. 27.

If an OK button 6304 is clicked, the setting made in this dialog screen becomes effective and the dialog screen is closed. If a Cancel button 6305 is clicked, the setting made in this dialog screen is canceled and the dialog screen is closed. If a Help button 6306 is clicked, help information associated with this dialog screen is displayed.

FIG. 30 shows an example of the dialog screen which appears when the Add button 5307 in FIG. 28 is clicked. In FIG. 30, it is allowed to input user information in a text box 6401. A copy-forgery-inhibited pattern style to be assigned to the user information input in the text box 6401 is selected from a drop-down list box 6403. The copy-forgery-inhibited pattern styles displayed in the box 6403 are similar to those displayed in the box 6303 in FIG. 28 described above, and thus a duplicated explanation thereof is omitted herein.

If an OK button 6404 is clicked, the setting made in this dialog screen becomes effective and the dialog screen is closed. If a Cancel button 6405 is clicked, the setting made in this dialog screen is canceled and the dialog screen is closed. If a Help button 6406 is clicked, help information associated with this dialog screen is displayed.

Although in the present embodiment, it is assumed that new user information is added by inputting it via the box 6401, user information extracted from print jobs may be stored in a log file or the like and user information may be displayed in the form of a list so that it is allowed to select user information from the list. Alternatively, user information may be acquired from a system adapted to manage users on a network (for example, Active Directory in the Windows (trademark)) and may be displayed in the form of a list or the like such that it is allowed to select user information from the list. Note that there is no particular restriction on the method of acquiring user information as long as the data can be managed in a data format similar to that shown in FIG. 27.

In the present embodiment, as described above, the printer driver automatically sets the property of printing of a copy-forgery-inhibited pattern image in accordance with user information. This makes it possible to properly set the property of a copy-forgery-inhibited pattern image each time an image such as a document is printed, without needing an operation by a user, that is, without depending on an arbitrary decision by the user.

### Third Exemplary Embodiment

In a third embodiment described below, file information shown in FIG. 22, and information indicating the correspondence between confidentiality levels and copy-forgery-inhibited pattern styles shown in FIG. 23 are stored in an external computer (a document management server), and the process defined in the flow chart shown in FIG. 21 and the process from step S5105 to step S5103 in the flow chart shown in FIG. 20 are executed by the external computer. A computer similar to the host computer 3000 used in the first or the second embodiment described above may be used as the external computer according to the present embodiment.

In this case, the external computer first detects an identifier of a document selected on a client computer via a network. Thereafter, in accordance with the detected identifier, setting information indicating a confidentiality level assigned to the identifier of the document is acquired in step S5101.

If the determination in step S5103 is affirmative, then the external computer issues a command to the client computer via the network to perform printing in accordance with the assigned copy-forgery-inhibited pattern style in a similar manner to step S5104. If the client computer receives the command, the client computer performs printing such that a copy-forgery-inhibited pattern of the specified copy-forgery-inhibited pattern style is applied to a document. Note that the command sent to the client computer includes at least information indicating the specified copy-forgery-inhibited pattern style (such as that described in the field 5402 in FIG. 23). Herein, the information is described in a similar format to the format in which the information associated with the setting of the copy-forgery-inhibited pattern is represented in step S5104 according to the first embodiment described above. That is, the information includes a character string to be used as the copy-forgery-inhibited pattern, style information (the type of the copy-forgery-inhibited pattern), etc.

The client computer includes a module having capabilities similar to those of the copy-forgery-inhibited pattern processing unit 205, and this module analyzes the copy-forgery-inhibited pattern setting information received from the external computer and applies a copy-forgery-inhibited pattern image to document image in accordance with the result of the analysis.

In the case in which the determination in step S5103 is negative, the external computer sends a command to the client computer via the network to perform printing in accordance with an existing (current) copy-forgery-inhibited pattern style in a similar manner to step S5105. Also in this case, the module, similar to the copy-forgery-inhibited pattern processing unit 205, provided in the client computer analyzes the received command and performs printing of a copy-forgery-inhibited pattern image in accordance with the command. The existing (current) copy-forgery-inhibited pattern style may be set by the client computer in a similar manner as described above with reference to FIGS. 15 and 16.

Note that the third embodiment disclosed herein may be applied to the second embodiment described.

As can be seen from the above explanation, the third embodiment allows documents to be shared by a plurality of client computers via a network. In this case, an administrator or a similar user who manages the documents is allowed to define copy-forgery-inhibited pattern styles for respective documents which are shared by the plurality of client computers.

### Fourth Exemplary Embodiment

In the first embodiment described above, a copy-forgery-inhibited pattern image is applied to a document in accordance with a confidentiality level defined for the document. In the second embodiment, a copy-forgery-inhibited pattern image is applied to a document not according to a confidentiality level but according to user information. In the third embodiment, management of copy-forgery-inhibited pattern styles assigned to respective documents is performed not by the client computer but by the external computer, and management information is supplied from the external computer to the client computer via a network. In a fourth embodiments described below, modifications to the first to third embodiments are discussed.

Process Performed by Host Computer

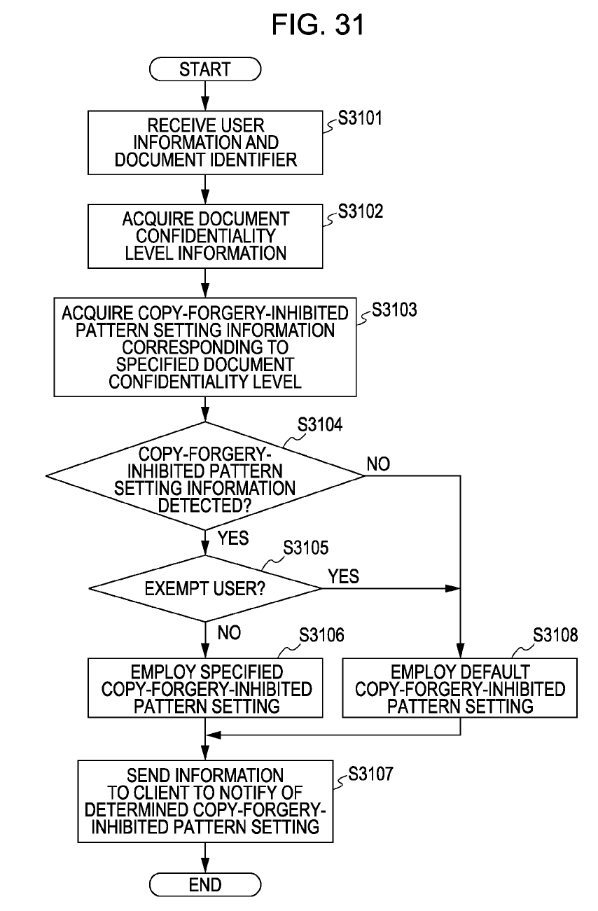

Referring to flow chart shown in FIG. 31, a process performed by a host computer serving as a document management server according to the present embodiment is described below.

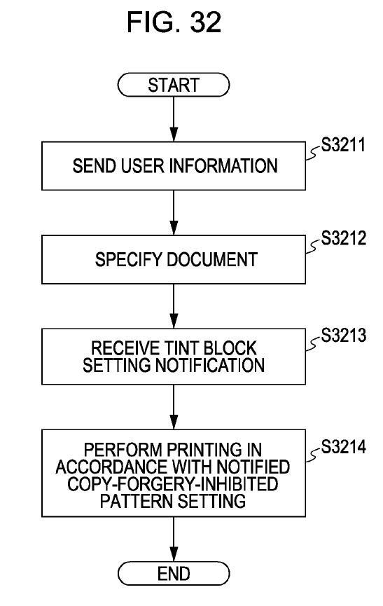

First, in step S3101, the host computer 3000 receives user information and a document identifier from one of external client computers and identifies the received user information and the document identifier. The user information received in this step is that issued in step S3211 shown in FIG. 32, and the document identifier is that specified in step S3212 in FIG. 32. Note that both the user information and the document identifier are sent from the client computer. The document identifier is similar to that used in the first embodiment described above, and the user information is similar to that used in the second embodiment.

In following steps S3102, S3103, and S3104, the host computer 3000 acquires information indicating a confidentiality level assigned to the document and information indicating the correspondence between copy-forgery-inhibited pattern styles and confidentiality levels in similar manners to those in steps S5101 and S5102 shown in FIG. 20. In step S3104, as in step S5104, it is determined whether the copy-forgery-inhibited pattern style corresponding to the confidentiality level determined in step S3103 is included in a set of predefined copy-forgery-inhibited pattern styles such as those described above with reference to FIGS. 23 and 24.

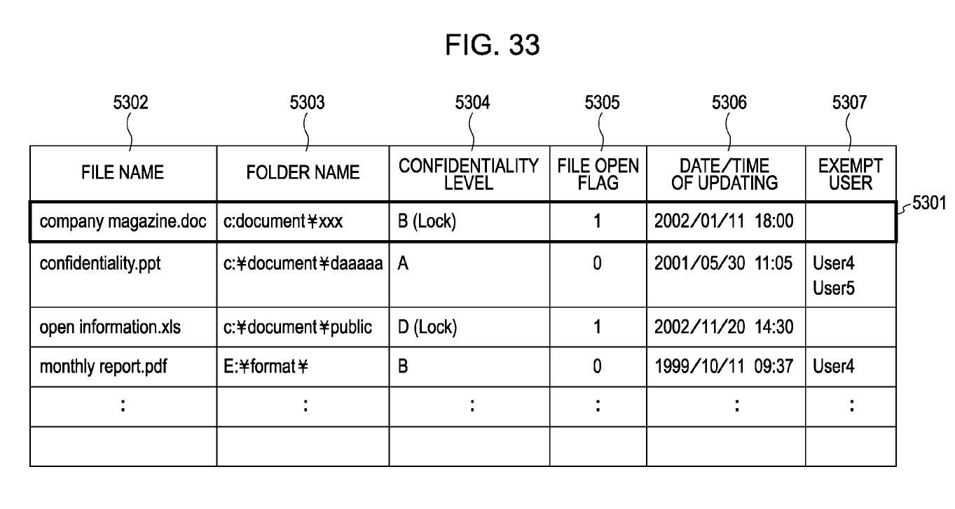

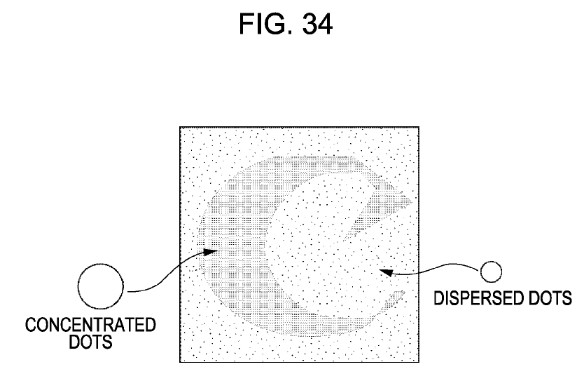

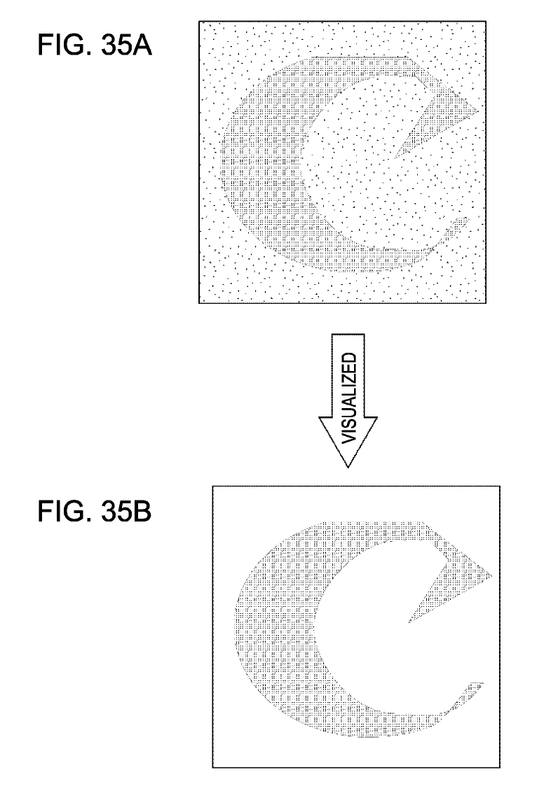

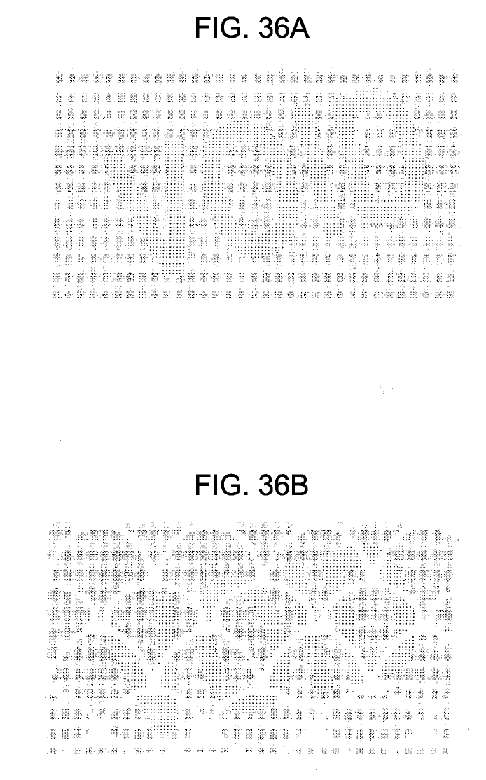

If the answer to step S3104 is Yes, the process proceeds to step S3105. In step S3105, it is determined whether the user information received in step S3101 is included in a set of user information identifying exceptional users defined for the document specified by the client computer. More specifically, the host computer 3000 examines the file information shown in FIG. 33 to determine whether the use identified by the user information received in step S3101 is one of exceptional users defined for the specified document.

If it is determined in step S3105 that the user identified by the user information identified in step S3101 is one of exceptional users defined for the specified document data specified in step S3101, it is allowed to perform setting associated with the copy-forgery-inhibited pattern image without depending on the confidentiality level defined for the document data. On the other hand, if it is determined in step S3105 that the user identified by the user information identified in step S3101 is not included in the exceptional users defined for the document data specified in step S3101, setting associated with the copy-forgery-inhibited pattern image is performed in accordance with the confidentiality level defined for the specified document data.

Thus, if the answer to step S3105 is No, it is determined that the copy-forgery-inhibited pattern style corresponding to the file information as defined in FIG. 33 is employed as a copy-forgery-inhibited pattern style to be notified to the client computer in a following step S3107. In step S3107, a notification is sent to the client computer to notify that the copy-forgery-inhibited pattern style determined in the previous step should be employed for the document. Note that the settings associated with the copy-forgery-inhibited pattern printing are similar to those employed in step S5104 in FIG. 20 according to the first embodiment.

On the other hand, if the answer to step S3104 is No or if the answer to step S3105 is Yes, the process proceeds to step S3108. In step S3108, it is determined that an existing (current) copy-forgery-inhibited pattern style is employed as a copy-forgery-inhibited pattern style to be notified to the client computer. Note that the settings associated with the copy-forgery-inhibited pattern printing employed herein in step S3108 are similar to those employed in step S5105 in FIG. 20 according to the first embodiment. In step S3107, a notification is sent to the client computer to notify that the copy-forgery-inhibited pattern style determined in step S3108 should be employed in printing performed by the client computer. Note that the notification sent in step S3107 may be described in an arbitrary format as long as a processing unit, similar to the copy-forgery-inhibited pattern processing unit 205, of the client computer can correctly interpret the copy-forgery-inhibited pattern style (setting) determined in step S3106 or S3108. For example, settings defined via the setting screen such as that shown in FIG. 15 or 16 according to the first or second embodiment may be directly employed herein.

Process Performed by Client Computer

FIG. 32 is a flow chart showing a process performed by a client computer according to an embodiment of the present invention. In step S3211, the client computer sends user information to the host computer 3000. This step is performed at an arbitrary time, for example, when a command to print document data is issued or when the client computer sends information identifying document data to the host computer 3000. Note that, as for the user information for the present purpose, user information identifying a user who logs in to the client computer may be used, as in the second embodiment described above.

In step S3212, a document is specified in accordance with a selection command issued by a user and an identifier identifying the specified document is sent from the client computer to the host computer 3000. In this process, a user at the client computer views documents stored in the host computer 3000 serving as the document management server at a remote location, and the selection of a document by the user via the client computer is detected (in step S31012) by the host computer 3000.

In step S3213, the client computer receives a notification of a specified copy-forgery-inhibited pattern style from the host computer 3000. The notification received in this step S3213 corresponds to that issued in step S3107 in FIG. 31.

The client computer performs printing in accordance with the specified copy-forgery-inhibited pattern style received in step S3213 in a similar manner to step S5104 or S5105 in FIG. 20 described in detail above. A duplicated explanation thereof is omitted herein.

FIG. 33 shows a set of file information which is referred to by the host computer 3000 in the process shown in FIG. 31. Information described in fields 5301 to 5306 of file information are similar to those described above with reference to FIG. 22.

Information in a field 5307 of file information indicates exceptional users who are not subject to the rule of using a copy-forgery-inhibited pattern style specified for a confidentiality level. For exceptional users defined herein, the host computer 3000 makes an affirmative determination in step S3105. That is, for exceptional users defined in the field 5307, it is allowed to perform printing in accordance with setting performed in step S3108 regardless of the confidentiality level defined for the document specified by the client computer (even if the highest confidentiality level is assigned to the document). For example, administrators or users having a special right may be specified as exceptional users.

In the fourth embodiment, as described above, it is allowed to define exceptional users for respective documents thereby allowing it to embed copy-forgery-inhibited patterns in documents in a more flexible manner.

### Other Embodiments

Note that the present invention may be applied to a system including a plurality of apparatus or devices (such as a host computer, an interface device, a reader, a printer, etc,) or a single apparatus or a device (such as a copier, a printer, a facsimile machine, etc.).

The objects of the present invention may also be achieved by providing to a system or an apparatus a storage medium having software program code stored thereon for implementing the functions disclosed in the embodiments by executing the process defined, for example, in the flow chart shown in FIG. 20 or 26. The objects of the present invention may also be achieved by reading program code stored on a storage medium and executing the program code on a computer (or a CPU or an MPU) of a system or an apparatus.

In this case, the program code read from the storage medium implements the functions disclosed in the embodiments described above, and the storage medium on which the program code is stored falls within the scope of the present invention.

Specific examples of storage media which can be employed in the present invention to supply the program code include a floppy (registered trademark) disk, a hard disk, an optical disk, a magneto-optical disk, a CD-ROM, a CD-R, a magnetic tape, a nonvolatile memory card, and a ROM.

Furthermore, the functions according to any of the above-described embodiments of the present invention can be implemented not only by executing a program code on a computer, but also by performing a part or all of the process with an operating system (OS) running on the computer in accordance with the program code. Such implementation of the functions also falls within the scope of the invention.

A program may be loaded into a memory of an extension card inserted in a computer or into a memory of an extension unit connected to the computer, and the CPU or the like may perform part or all of the process according to the loaded program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-348251 filed Dec. 1, 2005 and No. 2006-297991 fled Nov. 1, 2006, which are hereby incorporated by reference herein in their entirety.

What is claimed is:

1. An information processing apparatus adapted to control printing of copy-forgery-inhibited pattern data embedded in document data, comprising:
a defining unit configured to define a confidentiality level, according to which to determine content of a copy-forgery-inhibited pattern, commonly to a plurality of document data such that it is allowed to change the confidentiality level of each document data as required;
a copy-forgery-inhibited pattern setting unit configured to, when one of the plurality of document data is specified, set the content of the copy-forgery-inhibited pattern to be embedded in the specified document data in accordance with a confidentiality level defined for the specified document data; and
a control unit configured to control printing in accordance with the specified document data and the content of the copy-forgery-inhibited pattern set by the copy-forgery-inhibited pattern setting unit.

2. The information processing apparatus according to claim 1, further comprising a user identification unit configured to determine user information identifying a user who has specified the document, wherein
the defining unit is configured to further assign user information to each document data, and
the copy-forgery-inhibited pattern setting unit sets the content of the copy-forgery-inhibited pattern such that in a case in which user information determined by the user identification unit is assigned to the specified document, the content of the copy-forgery-inhibited pattern is set without depending on the confidentiality level, however in a case in which the user information determined by the user identification unit is not assigned to the specified document, the content of the copy-forgery-inhibited pattern is set in accordance with the confidentiality level defined for the specified document.

3. The information processing apparatus according to claim 1, wherein the defining unit defines storage location information identifying a storage location of the document data, and, if a command to change the storage location of the document data is issued, the defining unit updates the storage location information while maintaining the confidentiality level defined for the document data.

4. The information processing apparatus according to claim 1, wherein in a case in which the content of the copy-forgery-inhibited pattern is not defined for a confidentiality level defined for the specified document in which the copy-forgery-inhibited pattern is to be embedded, the control unit controls the printing such that the printing is performed in accordance with the specified document data and a content of the copy-forgery-inhibited pattern set via a setting screen adapted to set the content of the copy-forgery-inhibited pattern.

5. The information processing apparatus according to claim 1, wherein the copy-forgery-inhibited pattern setting unit sets the content of the copy-forgery-inhibited pattern to particular one or more document data such that no copy-forgery-inhibited pattern data is embedded in the particular document data, and, if the specified document data is one of the particular document data in which no copy-forgery-inhibited pattern data is to be embedded, the control unit controls the printing such that no copy-forgery-inhibited pattern is embedded in the specified document data.

6. The information processing apparatus according to claim 5, wherein when the specified document data is one of the particular document data specified by the copy-forgery-inhibited pattern setting unit so as to be not subject to the application of any copy-forgery-inhibited pattern, the control unit controls the printing such that no copy-forgery-inhibited pattern is embedded in the specified even if it is specified to embed a copy-forgery-inhibited pattern in the specified document via the setting screen adapted to set the content of the copy-forgery-inhibited pattern.

7. A method of controlling printing such that copy-forgery-inhibited pattern data is embedded in document data, the method comprising:
defining a confidentiality level, according to which to determine a content of a copy-forgery-inhibited pattern, commonly to a plurality of document data such that it is allowed to change the confidentiality level of each document data as required;
when one of the plurality of document data is specified, setting the content of the copy-forgery-inhibited pattern to be embedded in the specified document data in accordance with a confidentiality level defined for the specified document data; and
controlling printing in accordance with the specified document data and the content of the copy-forgery-inhibited pattern set for the specified document data.

8. The method according to claim 7, further comprising:
determining user information identifying a user who has specified the document; and
assigning user information to each document data,
wherein if the determined user information is assigned to the specified document, the content of the copy-forgery-inhibited pattern is set without depending on the confidentiality level, and if the determined user information is not assigned to the specified document, the content of the copy-forgery-inhibited pattern is set in accordance with the confidentiality level defined for the specified document.

9. The method according to claim 7, further comprising defining storage location information identifying a storage location of the document data, and, if a command to change the storage location of the document data is issued, updating the storage location information while maintaining the confidentiality level defined for the document data.

10. The method according to claim 7, wherein if the content of the copy-forgery-inhibited pattern is not defined for a confidentiality level defined for the specified document in which the copy-forgery-inhibited pattern is to be embedded, the printing is controlled such that the printing is performed in accordance with the specified document data and a content of the copy-forgery-inhibited pattern set via a setting screen adapted to set the content of the copy-forgery-inhibited pattern.

11. The method according to claim 7, wherein the content of the copy-forgery-inhibited pattern is set to particular one or more document data such that no copy-forgery-inhibited pattern data is embedded in the particular document data, and if the specified document data is one of the particular document data in which no copy-forgery-inhibited pattern data is to be embedded, the printing is controlled such that no copy-forgery-inhibited pattern is embedded in the specified document data.

12. The method according to claim 11, wherein if the specified document data is one of the particular document data specified not to be subject to the application of any copy-forgery-inhibited pattern, the printing is controlled such that no copy-forgery-inhibited pattern is embedded in the specified document data even if it is specified to embed a copy-forgery-inhibited pattern in the specified document data via the setting screen adapted to set the content of the copy-forgery-inhibited pattern.

13. A storage medium storing instructions which, when executed by an apparatus, cause the apparatus to perform operations comprising:
defining a confidentiality level, according to which to determine a content of a copy-forgery-inhibited pattern, commonly to a plurality of document data such that it is allowed to change the confidentiality level of each document data as required;
when one of the plurality of document data is specified, setting the content of the copy-forgery-inhibited pattern to be embedded in the specified document data in accordance with a confidentiality level defined for the specified document data; and
controlling printing in accordance with the specified document data and the content of the copy-forgery-inhibited pattern set for the specified document data.
